(19) United States
(12) Patent Application Publication
(10) Pub. No.: US 2006/0003838 A1
(43) Pub. Date: Jan. 5, 2006

(54) Game system, server, and game control method

(75) Inventors: Takahiko Kobayashi, Tokyo (JP); Junichi Kogo, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 11/171,432

(22) Filed: Jul. 1, 2005

(30) Foreign Application Priority Data
Jul. 1, 2004 (JP) 2004-196033

(51) Int. Cl. A63F 13/00

(52) U.S. Cl. 463/29

(57) ABSTRACT

A game system in which a plurality of terminal devices 1, an arcade server 2, and a center server 3 are connected with one another via a communication line 4, and in which a plurality of players can execute a game by operating the plurality of terminal devices 1, respectively. In the game system, the game histories of the players, which comprise a plurality of types of elements, are used to generate evaluation messages for game results corresponding to the game histories, the plurality of evaluation messages are then edited in accordance with a time axis in the game to generate an evaluation message group, and an image representing the evaluation message group is displayed.

### RELATED APPLICATIONS

This application claims the priority of Japanese Patent Application No. 2004-196033 filed on Jul. 1, 2004, which is incorporated herein by reference. Further, this application is related to two U.S. patent applications, which will be filed with the U.S. Patent Office by Jul. 1, 2005 based on Japanese Patent Application Nos. 2004-196030 (filed on Jul. 1, 2004) and 2004-196031 (filed on Jul. 1, 2004); and based on Japanese Patent Application Nos. 2004-196032 (filed on Jul. 1, 2004) and 2004-344679 (filed on Nov. 29, 2004) respectively. These applications including specifications, drawings, and claims are expressly incorporated herein by reference in their entirety.

### BACKGROUND OF THE INVENTION

1. Field of the Invention

The present invention relates to a game system in which a plurality of terminal devices are connected to servers via a communication line, a server which configures the game system, and a game control method which is executed by the server. Particularly, the present invention relates to a game system in which massively multiplayer online games such as MMORPG (Massively Multiplayer Online Role Playing Game), RTS (Real Time Strategy), FPS (First Person Shooting Game) and the like are executable, a server which configures the game system, and a game control method which is executed by the server.

2. Description of the Prior Art

In recent years, along with development of information and communications technology, a game system is widely used in which a plurality of terminal devices for game-arcade use or domestic use are connected to the servers by means of communication lines, and various online games can be executed in the game system. Recently, for example, massively multiplayer online games such as MMORPG (Massively Multiplayer Online Role Playing Game), RTS (Real Time Strategy), FPS (First Person Shooting Game) and the like are provided as the online games.

From the perspective of a player, in such massively multiplayer online games, the player can play a game with an unspecified number of players through the network such as Internet in remote locations nationally or internationally, without even knowing each other's face. The big attraction of the massively multiplayer online games is that the players can communicate with each other by means of such a medium as a game, thus it is strongly supported by many countries in the world. From the perspective of a game production company, in the massively multiplayer online games, the data or programs related to a new event, character, item and the like are sequentially updated and distributed to each terminal device via the network, thus a game environment can be constructed in which the player can continue playing a game semipermanently without getting bored with it. Therefore, it has the advantage of being able to secure the stability of earnings.

In the massively multiplayer online games, generally a character corresponding to each player is established, and the player participates in a game in a virtual space of the game by operating the player's own character. As the player acquaints himself with the game, the corresponding character clears various conditions (so called “mission”) to gain experience. As a result, the player or the character operated by the player can increase the level established inside the game, and the capability or position improves inside the game as the level increases, whereby various functions can be operated. Further, when the conditions are cleared, the amount of cash according to the degree of difficulty of the condition is granted to the player as a reward so as to be used during a game, thus the more conditions the player clears, the more cash which can be used in a game the player can acquire, whereby the player can purchase a weapon, item, and the like which can be used in a game so as to play the game advantageously.

Meanwhile, some online games display a game result (for example, the highest score, the title/designation acquired in the game, or the like) of each player. In some online games, since an unspecified number of players participate in a game, a successful player can feel superior and at the same time encourage a spirit of competition of other player, so the players can be caught up in the game enthusiastically. Furthermore, in some online games, the server creates a chronological table for the mission of the game according to the time axis in the game, and the name of the player who cleared the mission, and the game result up to clearing the mission are posted on the chronological table, which is then displayed to the terminal device (see Japanese Unexamined Patent Publication No. 2002-224450, for example). According to this, for example, players who met online but are unacquainted with each other can speak proudly to each other about their names are posted on the chronological table, or can share their experiences and the like in a game by means of the chronological table.

However, a game result displayed in the terminal device is only a game result in a specific point in time such as a game result during a game, a final game result, or the like, which is low-value for the player, thus there is a problem in which the game was made uninteresting. Moreover, as described in Japanese Unexamined Patent Publication No. 2002-224450, once the chronological table is created for the missions of the game based on the time axis in the game, only the names of skilled players are posted on the chronological table as the names of the players who cleared the mission, thus the problem is that it is difficult for a beginner to enjoy the game. Furthermore, another problem is that, even if there is posted on the chronological table a game result with which the player is not satisfied, it has to be tolerated since the same chronological table is created for all players.

### SUMMARY OF THE INVENTION

The present invention is contrived in consideration of the above problems, and the object thereof is to provide a game system which can display a valuable and interesting game result for a player, which a successful player can view repeatedly so as to feel superior and satisfied therefrom, and which other player refers to and has as an object, so as to play the game.

In order to solve the above-described problems, the present invention provides the following.

A game system in which at least a plurality of terminal devices are connected to servers via a communication line, and which can execute a game which a plurality of players play by operating each of the terminal devices, the game system comprising:
game history storing means for storing a plurality of game histories of a player, which comprise a plurality of types of elements;
game history setting means for setting the game histories comprising the plurality of types of elements on the basis of a game result of the player, and storing the game histories in the game history storing means after relating the game histories to the time in the game;
evaluation message generating means for generating an evaluation message for the game result corresponding to the game histories by means of the plurality of types of elements of the game histories for each game history stored in the game history storing means;
evaluation message group generating means for editing the plurality of evaluation messages generated in the evaluation message generating means in accordance with the time axis in the game, and generating an evaluation message group which represents a game process of the player; and
displaying means for generating an image constituted by the evaluation message group representing the evaluation message group generated by the evaluation message group generating means, and displaying the image constituted by the evaluation message group.

It should be noted that the elements constituting the game histories are not particularly limited. The game histories include, for example, the types of conditions, time required for clearing the conditions, amount of cash which is acquired by the player when clearing the conditions and can be used in the game, an item in a game, which is acquired by the player up to the point when clearing the conditions, level and capability values in the game, which are established to the player, various information items related to the other participating players, and the like.

Further, the present invention provides the following.

The game system described above, comprising evaluation message erasing means for erasing the evaluation message generated in the evaluation message generating means in accordance with an operation of the payer.

Further, the present invention provides the following.

The game system described above, comprising:
condition setting means for setting a condition to be cleared for a player; and
condition achievement determination means for determining whether or not the player clears the condition,
wherein, when the condition achievement determination means determines that the player clears the condition, the game history setting means sets a game history comprising a plurality of types of elements on the basis of a result of clearing the condition, and stores the game history in the game history storing means after relating same to the time in the game.

Further, in the game system according to the present invention, the server may comprise an arcade server connected communicably to the plurality of terminal devices via dedicated lines, and a center server connected communicably to the plurality of arcade servers via communication lines.

Further, in the game system according to the present invention, the game history may comprise at least two elements of the elements of a date and hour of participation, a participating player, the level of the participating player at the time of participation, a clearing time, and a reward acquired.

Further, in the game system according to the present invention, the displaying means may be provided in the terminal device or a card machine.

Further, the game system according to the present invention may be configured such that the game history is once stored in the memory of the arcade server, and the game history stored in the memory of the arcade server is transmitted to the center server when the game ends.

Further, in the game system according to the present invention, the evaluation message generating means may be provided inside the center server.

Further, in the game system according to the present invention, calculation of a time of the time axis in the game may be performed based on a timer value provided in the center server.

Further, in the game system according to the present invention, the game history setting means may be provided in the arcade server, the game history storing means may be provided in the arcade server or the center server, and the evaluation message generating means and the evaluation message group generating means may be provided in the center server.

Further, in the game system according to the present invention, the server may comprise the arcade server connected communicably to the plurality of terminal devices via dedicated lines, and the center server connected communicably to the plurality of arcade servers via communication lines, and the evaluation message erasing means may be provided in the center server, in which, on the basis of a request signal for erasing an evaluation message transmitted to the center server, erasing processing may be performed on the evaluation message.

In addition, the present invention provides the following.

A server, which is connected to at least a plurality of terminal devices via communication lines, and configures a game system in which a plurality of players can execute a game by operating the terminal devices respectively, the server comprising:
game history storing means for storing a plurality of game histories of the players, which comprise a plurality of types of elements;
game history setting means for setting the game histories comprising the plurality of types of elements on the basis of a game result of the player, and storing the game histories in the game history storing means after relating the game histories to the time in the game;
evaluation message generating means for employing the plurality of types of elements of the game histories to generate evaluation messages for game results corresponding to the game histories, for each game history stored in the game history storing means; and
evaluation message group generating means for editing the plurality of evaluation messages generated by the evaluation message generating means in accordance with a time axis in the game, and generates an evaluation message group representing the game processes of the players.

Moreover, the present invention provides the following.

A game control method, which causes a server to function as:
game history storing means for storing a plurality of game histories of the players, which comprise a plurality of types of elements;
game history setting means for setting the game histories comprising a plurality of types of elements on the basis of a game result of the player, and storing the game histories in the game history storing means after relating the game histories to the time in the game;
evaluation message generating means for employing the plurality of types of elements of the game histories to generate evaluation messages for game results corresponding to the game histories, for each game history stored in the game history storing means;
evaluation message group generating means for editing the plurality of evaluation messages generated by the evaluation message generating means in accordance with a time axis in the game, and generating an evaluation message group representing the game processes of the players; and
displaying means for generating an image configured by the evaluation message group representing the evaluation message group which is generated by the evaluation message group generating means, and displaying the image configured by the evaluation message group,
wherein the server is connected to at least a plurality of terminal devices via communication lines, and configures game system in which a plurality of players can execute a game by operating the terminal devices.

### BRIEF DESCRIPTION OF THE DRAWINGS

FIG. 1 is a configuration diagram of the game system according to the present invention;

FIG. 2 is a perspective view showing the exteriors of eight terminal devices 1 installed in one arcade, and a card machine 6;

FIG. 3 is a perspective view showing the exterior of the terminal device 1;

FIG. 4 is a block diagram showing a hardware configuration of the terminal device 1;

FIG. 5 is a block diagram showing a hardware configuration of an arcade server 2;

FIG. 6 is a block diagram showing a hardware configuration of a center server 3;

FIG. 7 is a block diagram showing a hardware configuration of the card machine 6;

FIG. 8 is a figure showing a flow of a game played in the game system of the present embodiment;

FIG. 9 is a flow chart showing a flow of a processing of until an ID card is issued in the card machine 6, arcade server 2 and center server 3;

FIG. 10 is a figure showing information on participation of players;

FIGS. 11A to 11C are figures for explaining the detail of a data transmission processing performed by the arcade server 2;

FIG. 12 is a flow chart showing a flow of processings of until a game start in the terminal device 1, arcade server 2 and center server 3;

FIGS. 13A and 13B are figures showing an example of the historical data;

FIG. 14 is a figure showing an example of the player information;

FIG. 15 is a flow chart showing a routine of a game execution processing which is executed by the terminal device 1;

FIG. 16 is a flow chart showing a routine of a guild execution processing which is called up in the step S120 of the flow chart shown in FIG. 15 and is executed by the terminal device 1;

FIGS. 17A and 17B are figures schematically showing images which are displayed on a first display 11 of the terminal device 1 when the sub routine shown in FIG. 16 is executed;

FIG. 18 is a flow chart showing a routine of a mission reference/acceptance processing which is called up in the step S131 of the flow chart shown in FIG. 16 and executed by the terminal device 1;

FIG. 19 is a flow chart showing a processing executed by the arcade server 2 in accordance with the sub routine shown in FIG. 18, which is executed by the terminal device 1;

FIG. 20 is a figure showing mission list data;

FIGS. 21A to 21D are figures schematically showing images displayed on the first display 11 of the terminal device 1 when the sub routine shown in FIG. 18 is executed;

FIG. 22 is a flow chart showing a notice board use processing which is called up in the step S133 of the flow chart shown in FIG. 16 and is executed by the terminal device 1, and a processing executed by the arcade server 2 in accordance with the abovementioned processing;

FIG. 23 is a figure showing an example of a message list;

FIGS. 24A to 24C are figures schematically showing images displayed on the first display 11 of the terminal device 1 when the processing shown in FIG. 22 is executed;

FIG. 25 is a flow chart showing a reward payment processing which is called up in the step S135 of the flow chart shown in FIG. 16 and is executed by the terminal device 1, and a processing executed by the arcade server 2 in accordance with the abovementioned processing;

FIG. 26 is a figure showing an example of a reward determination table;

FIG. 27 is a flow chart showing a routine of a mission game execution processing which is called up in the step S121 of the flow chart shown in FIG. 15 and is executed by the terminal device 1;

FIG. 28 is a flow chart showing a processing executed by the arcade server 2 in accordance with the sub routine shown in FIG. 27, which is executed by the terminal device 1;

FIG. 29 is a figure showing an example of a chat message list;

FIGS. 30A to 30D are figures showing an example of images which are displayed on the first display 11 of the terminal device 1 by executing the processings shown in FIG. 27 and FIG. 28;

FIG. 31 is a flow chart showing a biographical data generation processing which is executed by the center server 3;

FIG. 32 is a figure showing an example of a historical data evaluation table;

FIG. 33 is a figure showing an example of an evaluation message creation table;

FIG. 34 is a flow chart showing a processing which is executed by the card machine 6 and center server 3 when displaying a biographical image;

FIGS. 35A and 35B are figures showing an example of biographical images displayed on a display 61 of the card machine 6 when the processing shown in FIG. 34 is executed; and

FIG. 36 is a configuration diagram showing another example of the game system according to the present invention.

### DESCRIPTION OF THE PREFERRED EMBODIMENTS

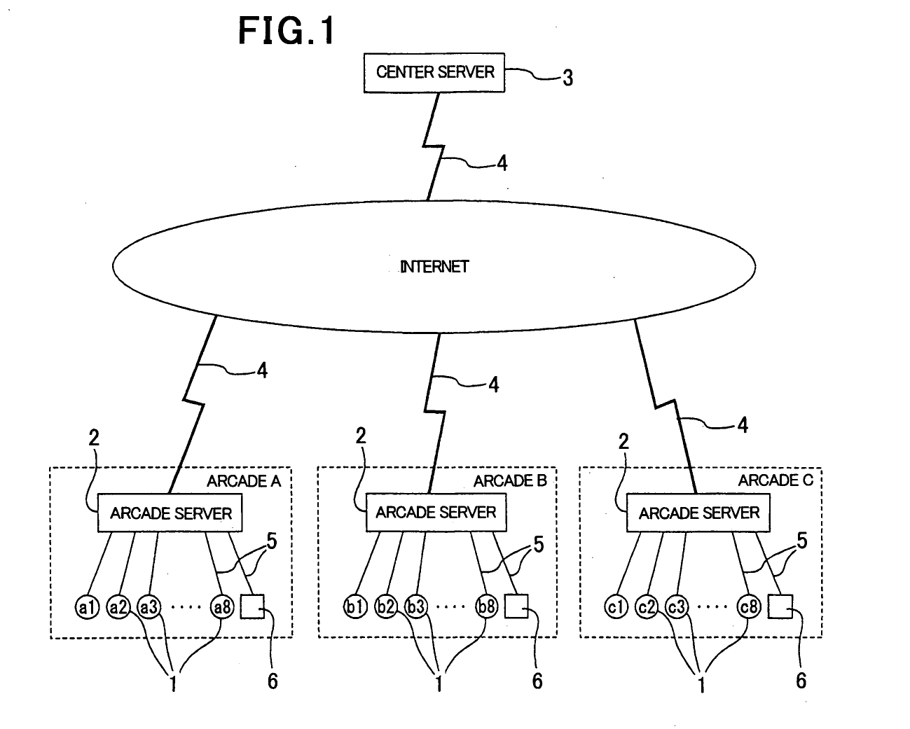

FIG. 1 is a configuration diagram of the game system according to the present invention. The game system comprises a plurality of terminal devices 1, an arcade server 2 connected communicably to the plurality of (eight devices here) terminal devices 1 by means of dedicated lines 5, a center server 3 which is connected communicably to a plurality of arcade servers 2 by means of a communication lines 4, and which manages a game played by a plurality of players using the terminal devices 1, and a card machine 6 connected to the arcade server 2 via the dedicated line 5 for each arcade 1. It should be noted that the arcade servers 2 can communicate with each other via the communication lines 4.

The terminal device 1 accepts a predetermined operation performed by a player using a touch panel 14 (not shown), and proceeds with a game on the basis of data transmitted from the arcade server 2 (or center server 3), data from another terminal device 1, and the like.

It should be noted that a unique machine ID is related to each machine of the terminal devices 1. The machine ID includes a code for each arcade server 2 connected to the terminal device 1, and a code for each terminal device 1 in the arcade in which the terminal devices 1 are disposed. For example, if the code of an arcade server A of an arcade A is A, and the code of the terminal device 1 in the arcade A is 1, the machine ID of the terminal device 1 is a1.

The arcade servers 2 are connected communicably to the plurality of terminal devices 1 (eight devices in this case) respectively and to the center server 3, and perform data transmission between the terminal devices 1 and the center server 3. The center server 3 is connected communicably to the plurality of arcade servers 2 and has historical data related to each player. The center server 3 performs data transmission with the terminal devices 1 via the arcade servers 2, and thereby performs processing such as authentication and the like of each player. The arcade server 2 is equivalent to the server in the present invention.

The card machine 6 can communicate with the center server 3 via the arcade server 2. The card machine 6 accepts an operation of the personal data input performed by a player, and issues an ID card 8 (not shown). The player is registered in the center server 3 by the personal data inputted at this time, and ID data which can identify the player is granted to each player by the center server 3. This ID data is granted beforehand to the ID card 8 to be issued. Further, a password, which is inputted by the player when the ID data is granted, is stored in a RAM 303, and used for authenticating the player when a game is started.

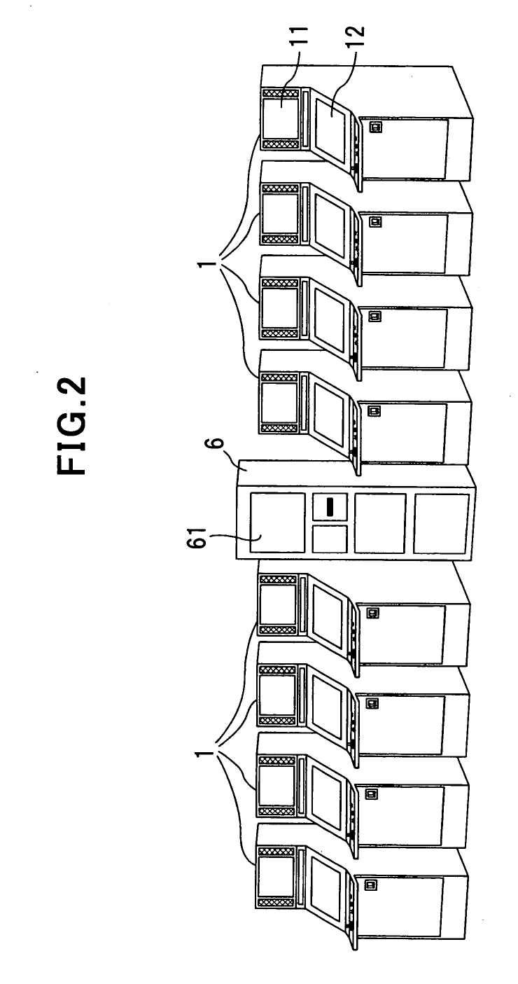

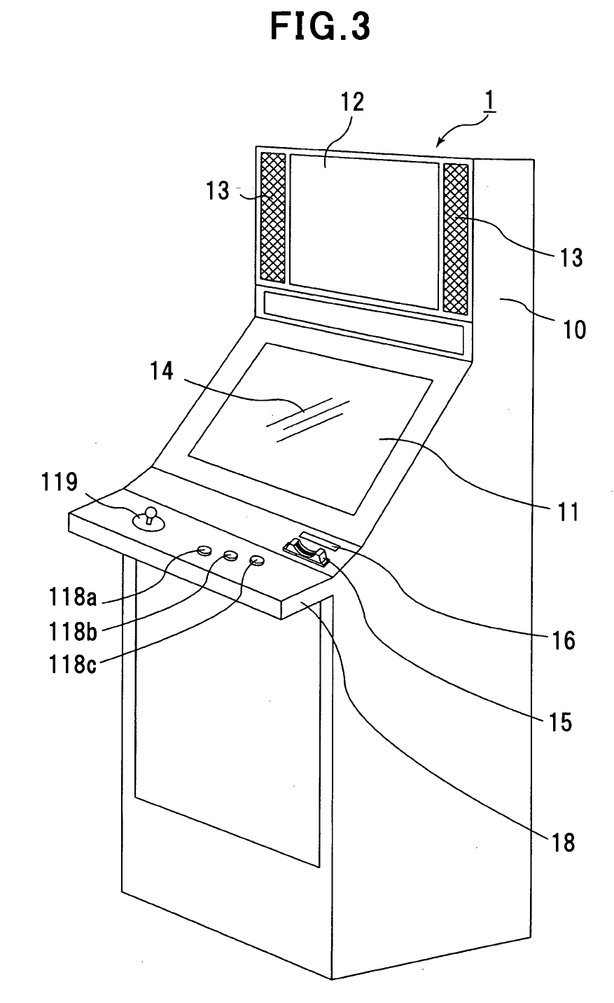

FIG. 2 is a perspective view showing the exteriors of eight terminal devices installed in one arcade, and the card machine. FIG. 3 is a perspective view showing the exterior of the terminal device. It should be noted that an arcade gaming device comprising two displays (a first display 11 and a second display 12) is explained as an example of the terminal device hereinbelow. However, the present invention is not particularly limited to this example, thus a home vide-game device configured by connecting the home vide-game device to a home television, a personal computer which functions as a vide-game device by executing a vide game program, and the like can be applied similarly.

Furthermore, in the present embodiment, a game performed using the terminal device 1 is a MMORPG (Massively Multiplayer Online Role Playing Game) in which the elements of an action game are applied. A player who operates each terminal device 1 uses various buttons 118 and an operation lever 119 to operate a character corresponding to the player, and plays a game. Each character belongs to a venturer guild in the game (a trading association configured by a venturer), and accepts a mission (a condition in the game, which is set for the player) from the guild. After accepting the mission from the guild, a mission game is played in which the character ventures a virtual game space. In the mission game the character can be reinforced by causing the character to battle against a monster and increasing the level, whereby an item can be acquired. A character corresponding to each of a plurality of players plays a game in the same virtual game space. Therefore, sometimes the character can challenge the mission along with a character corresponding to other player, or the character can exchange the information with the character of the other player. Once returning to the guild after clearing the above mission in the virtual game space, a reward corresponding to the type of mission can be acquired from the guild, and a new mission can be accepted.

As shown in FIG. 3, the terminal device 1 comprises a housing 10, a first display 11 provided on the front face of the housing 10, the first display 11 being inclined at a predetermined angle, and a second display 12 provided on the upper side of the first display 11. A game image showing a virtual game space where characters are disposed, an image showing a guild, and other images are displayed on the first display 11. Various images such as an image indicating a map of the virtual game space (overall view), a commercial image for a game, and other images are displayed on the second display 12.

The touch panel 14 is installed in front of the first display 11. The touch panel 14 can detect a contact by a player, and outputs a detection signal, which indicates a contact position when the contact is detected, to an operation input portion 114 (not shown) which is described hereinafter. The player can touch the touch panel 14 to input various instructions. The speakers 13 which output sound are provided at the sides of the second display 12.

The lower side of the first display 11 is provided with a coin insertion slot 15 into which a coin is inserted, and an ID card insertion slot 16 into which an ID card is inserted. A coin which is inserted into the coin insertion slot 15 is detected by a coin sensor 115 (not shown). Further, the ID data of an ID card inserted into the ID insertion slot 16 is read out by an ID card reader 116 (not shown).

The housing 10 is provided with an operation board 18 protruding forward. The front face of the operation board 18 is provided with an attack button 118a, a defense button 118b, a magic button 118c, and an operation lever 119. The attack button 118a is used to input an instruction for causing a character to perform an offensive move. The defense button 118b is used to input an instruction for causing the character to perform a defensive move. The magic button 118c is used to input an instruction for causing the character to perform an action to use magic. The operation lever 119 is used to input an instruction for moving the character.

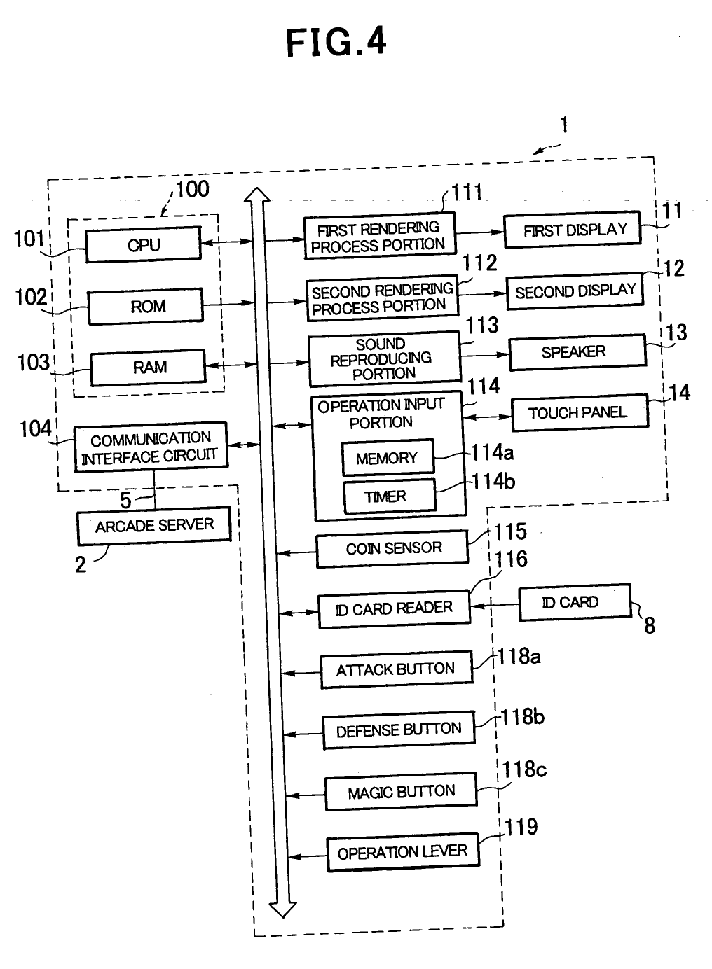

FIG. 4 is a block diagram showing a hardware configuration of the terminal device. A control portion 100 is to control the overall operation of the terminal device 1, and comprises a CPU 101, ROM 102, and RAM 103.

The ROM 102 stores various image data, programs, and the like. Specifically, the ROM 102 stores image data which indicates, for example, images displayed on the first display 11 and/or second display 12, such as various character images showing a character which can be operated by a player, a character operated by other player, and other characters, a monster image showing a monster which appears in a virtual game space, various background images for showing the virtual game space, an image showing a guild, and the like. Also the ROM 102 stores, for example, an object, texture data, background image, and the like that configure the character or monster. The object and the like that configure the character or monster are configured by a predetermined number of polygons such that they can be rendered three dimensionally. Moreover, the ROM 102 has stored therein a level of the player or of the character corresponding to the player, and a capability value setting table (not shown) where the character level and the capability value thereof are related to each other.

The ROM 102 may be a storage medium embedded in the terminal device 1, or may be an attachable/detachable storage medium. Further, the both may configure the ROM 102. In addition, among the various data stored in the ROM 102, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

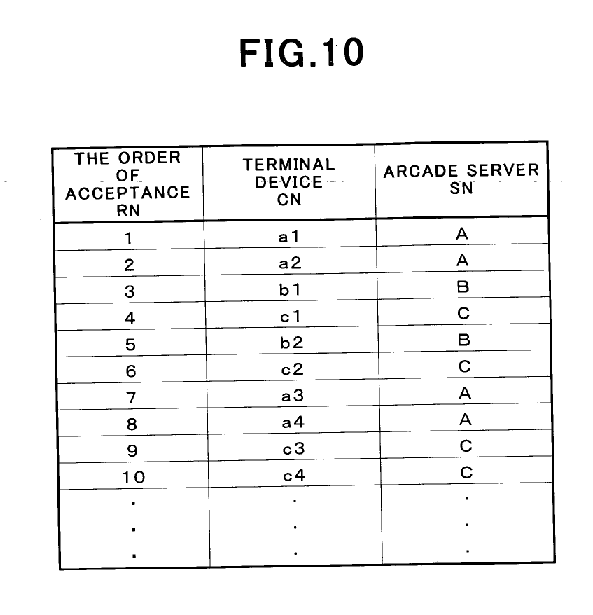

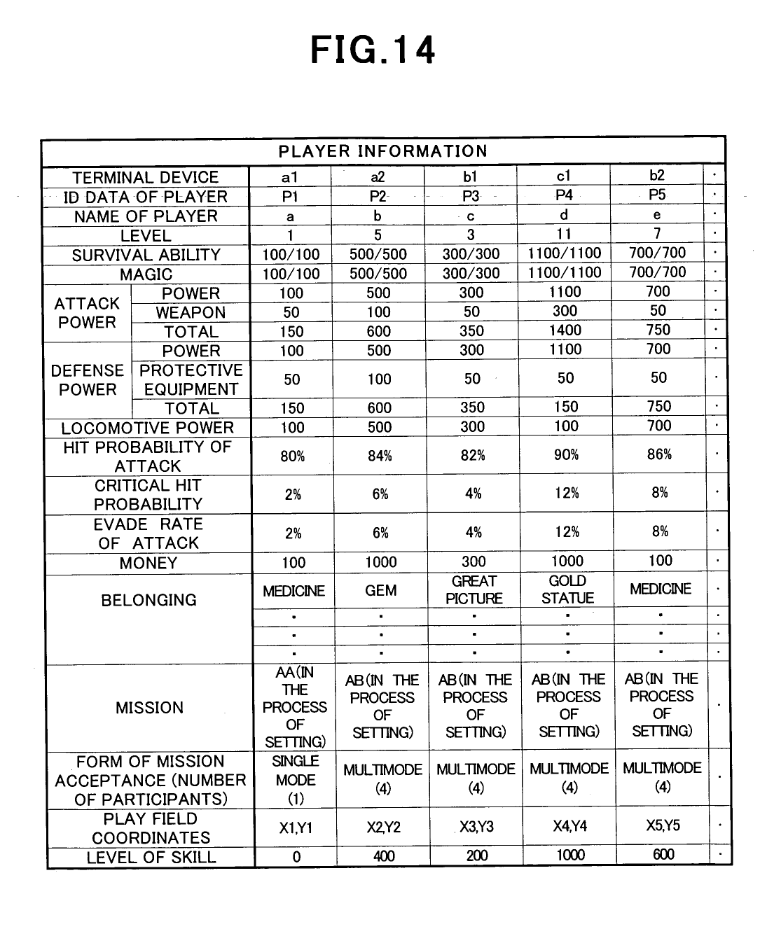

The RAM 103 stores information in processing, variables, and the like temporarily. For example, player participation information (see FIG. 10), player information (see FIG. 14), and the like are stored. The CPU 101 selects either a single mode in which a single player participates in a single mission (condition) in a game, or a multimode in which a player participates in the mission with other player, according to an input operation performed by the player using the touch panel 14, and stores a result of the selection in the player information.

A communication interface circuit 104 is used to perform data transmission (for example, the player participation information, player information, etc) with the arcade server 2 by means of the dedicated line 5. The communication interface circuit 104 transmits an instruction inputted by a player by means of the touch panel 14, the various buttons 118 or the operation lever 119 to the arcade server 2 via the dedicated line 5, and the arcade server 2 proceeds with the game based on the instruction. Also the communication interface circuit 104 receives a display command for the first display 11 and second display 12 from the arcade server 2 via the dedicated line 5. Various images are displayed each on the first display 11 and the second display 12 on the basis of the display command.

A first rendering process portion 111 displays a game image in which a character is disposed in the virtual game space, an image showing a guild, and the like on the first display 11, and comprises a VDP (Video Data Processor), a video RAM, and the like. The first rendering process portion 111 refers to the player information (see FIG. 14) stored in the RAM 103, and extracts the image data from the ROM 102, according to the above display command. The first rendering process portion 111 then stores the image data in the video RAM in accordance with priorities displayed on the first display 11 (for example, in the order of the background image, monster image, and character image), generates a game image, and outputs it to the first display 11. As a result, the game image is displayed on the first display 11. Further, when displaying the game image three dimensionally, the first rendering process portion 111 performs calculation for converting the object (for example, an object configuring a character or monster, and the like) stored in the ROM 102 from a position on the three dimensional space to a position on a pseudo three dimensional space, light source calculation processing, and the like, as well as a write processing of the image data (for example, mapping of the texture data for the region of the video RAM specified with a polygon) to be rendered to the video RAM on the basis of the results of the above calculations, thereby generating the game image, and outputs it to the first display 11. As a result, the three-dimensional game image is displayed on the first display 11.

A second rendering process portion 112 causes the second display 12 to display an image indicating a map of the virtual game space, a commercial image for a game, or other image, and comprises a VDP (Video Data Processor), a video RAM, and the like. The second rendering process portion 12 extracts a predetermined image from the ROM 102 according to the abovementioned display command. The second rendering process portion 112 then stores the image data in the video RAM in accordance with priorities displayed on the second display 12, thereby generating a predetermined image, and outputs it to the second display 12. As a result, the predetermined image is displayed on the second display 12.

A sound reproducing portion 113 outputs a predetermined sound, BGM and the like to the speakers 13 in accordance with an instruction from the arcade server 2. The touch panel 14 is a rectangular thin layer body provided in front of the first display 11, and is constituted such that a transparent pressure sensitive material in the form of a line, which is disposed at a predetermined pitch vertically and horizontally, is covered with a transparent cover. A conventionally known touch panel can be employed as the touch panel 14. The touch panel 14 outputs to the operation input portion 114 a detection signal indicating the contact position when being contacted.

The operation input portion 114 is a microcomputer comprising a memory 114a and a timer 114b, buffers the contact position, which is indicated by the detection signal outputted from the touch panel 14, as data to a predetermined region of the memory 114a, uses the timer 114b and the like to determine the detail of the instruction on the basis of the data sequentially, and supplies a result of determination as an operation command to the control portion 100.

The coin sensor 115 transmits a predetermined signal to the control portion 100 when a coin inserted into the coin insertion slot 15 is detected. The ID card reader 116 reads out the ID data from the ID card 8 which is inserted into the ID card insertion slot 16, and supplies it to the control portion 100. The attack button 118a is a button for causing a character to perform an offensive move, the defense button 118b is for causing the character to perform a defensive move, and the magic button 118c is for causing the character to perform an action to use magic. The various buttons 118 (118a to 118c) transmit the detection signal to the control portion 100 when detecting an operation by the player. The operation lever 119 transmits to the controller portion 100 a detection signal corresponding to a predetermined direction to which the player tilts the operation lever 119.

The present embodiment explains the case in which the terminal device 1 comprises the touch panel 14, various buttons 118, and operation lever 119 as the means for the player to input an instruction (input means). However, the terminal device 1 related to the present embodiment may comprise the touch panel 14 only, for example, or may comprise various buttons 118 and operation lever 119 only. Further, the input means that the terminal device 1 related to the present embodiment comprises is not limited to the above example, and, for example, the conventionally known input means such as a keyboard, mouse, pointing device and the like can be employed.

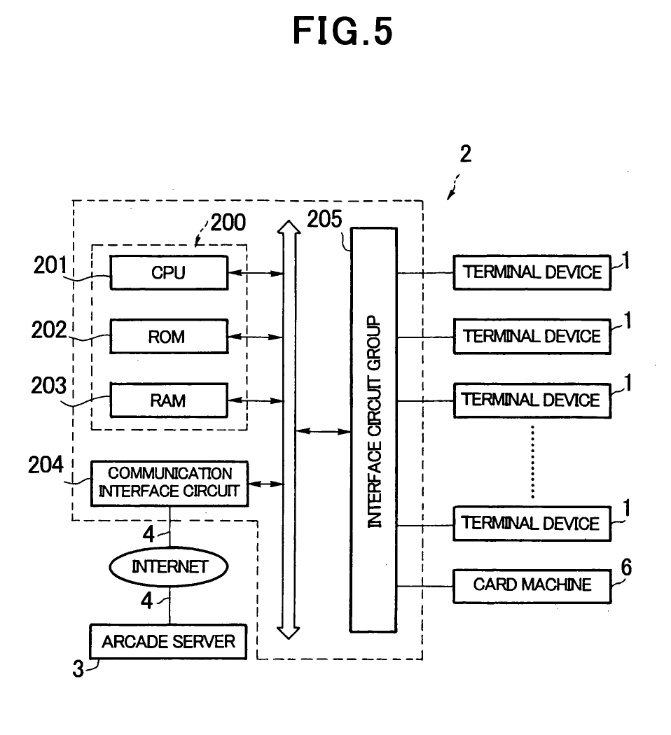

FIG. 5 is a block diagram showing a hardware configuration of an arcade server. The arcade server 2 comprises a control portion 200 which controls the overall operation of the arcade server 2. The control portion 200 comprises a CPU 201, ROM 202, and RAM 203.

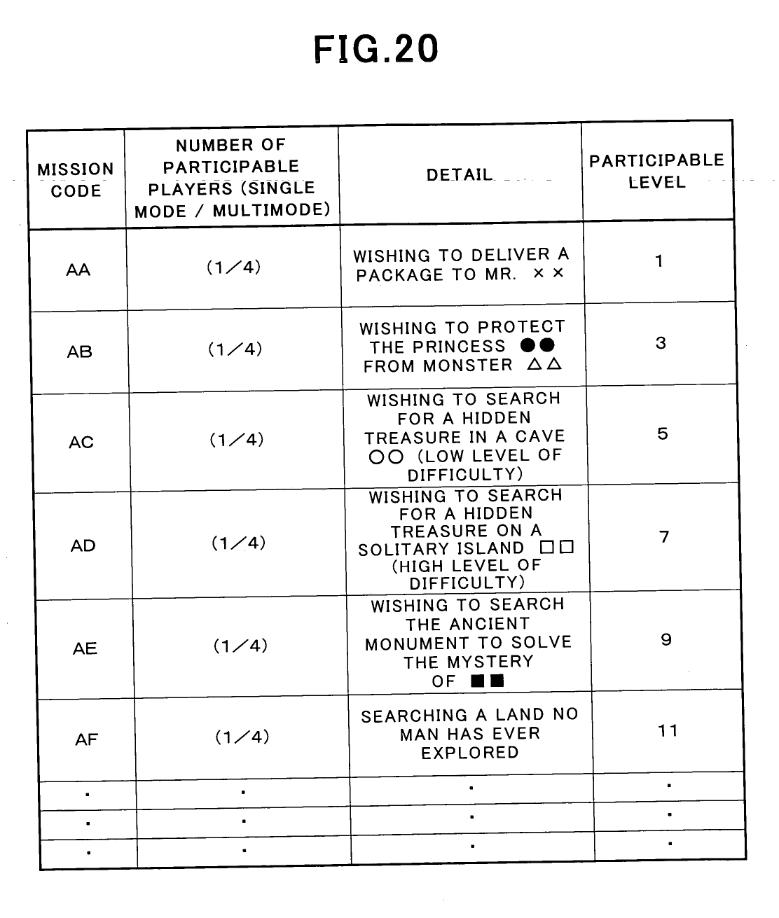

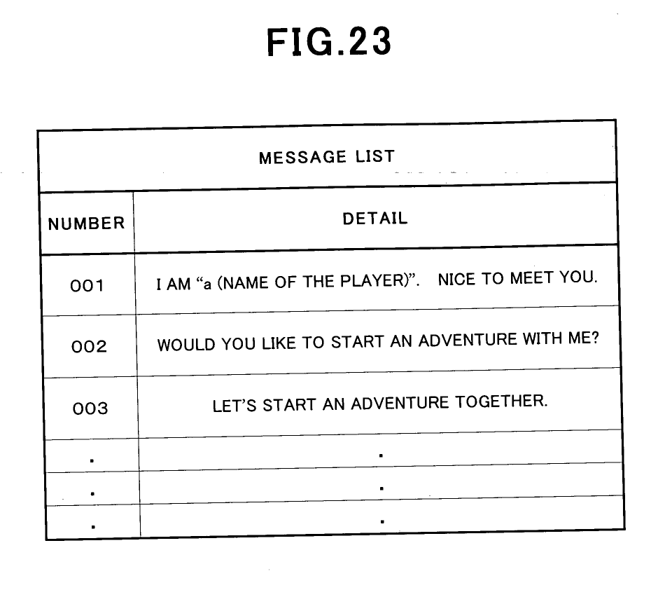

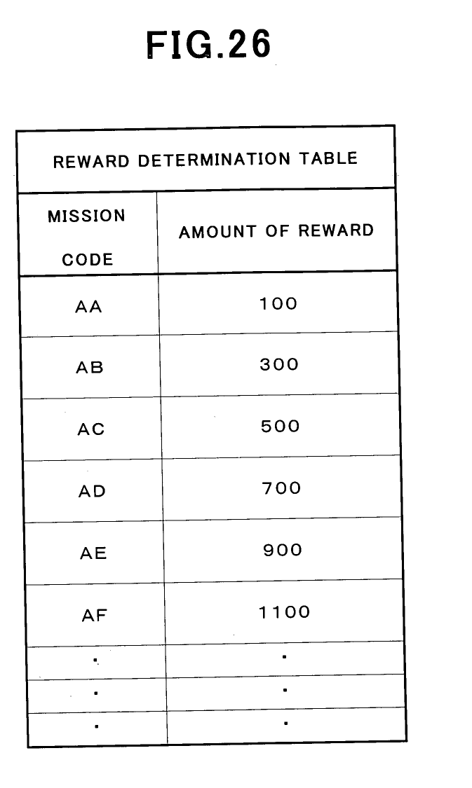

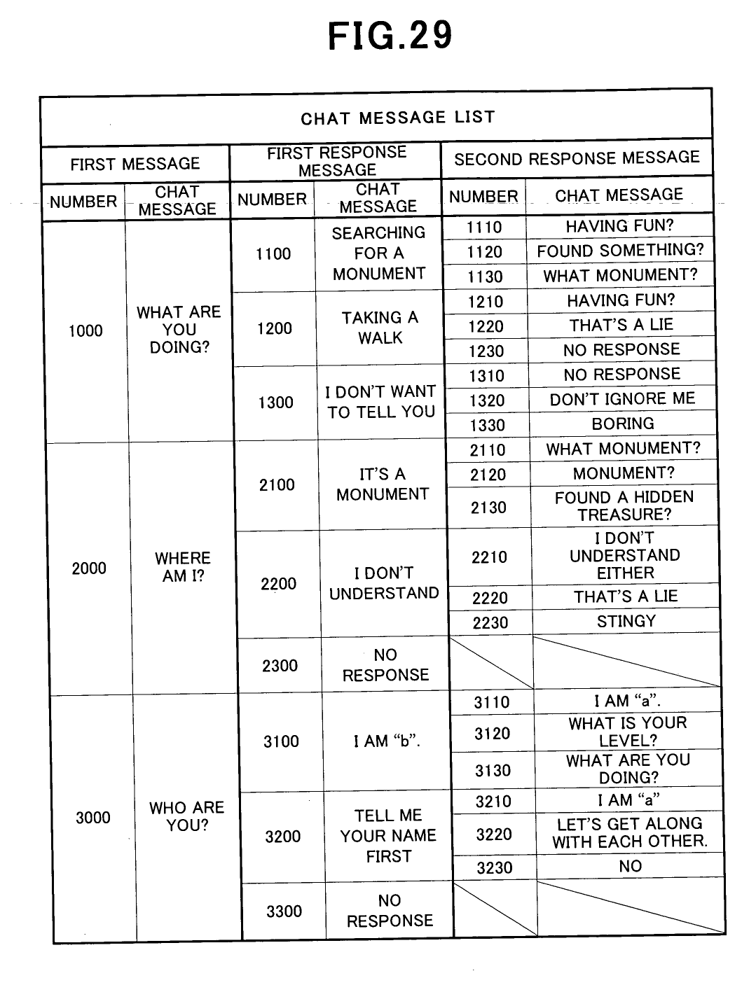

The ROM 202 stores a game control program. The CPU 201 of the arcade server 2 executes the game control program stored in the ROM 202, and performs various types of processing for proceeding with the game. Further, the ROM 202 stores various data, table data and the like used in the processing of a game, such as mission list data (see FIG. 20) showing a list of the missions set to a player in the game system of the present embodiment, mission reference data showing a detailed content and the like of each mission, a message list (see FIG. 23) in which is stored a message which can be inputted by the player in a guild notice board, a reward determination table (see FIG. 26) for determining the amount of a reward for clearing the mission, a chat message list (FIG. 29) used when exchanging the message (so called “chatting”) with other player in a mission game, and the like.

The ROM 202 may be a storage medium embedded in the arcade server 2, or may be an attachable/detachable storage medium. Further, the both may configure the ROM 202. In addition, among the various data stored in the ROM 202, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

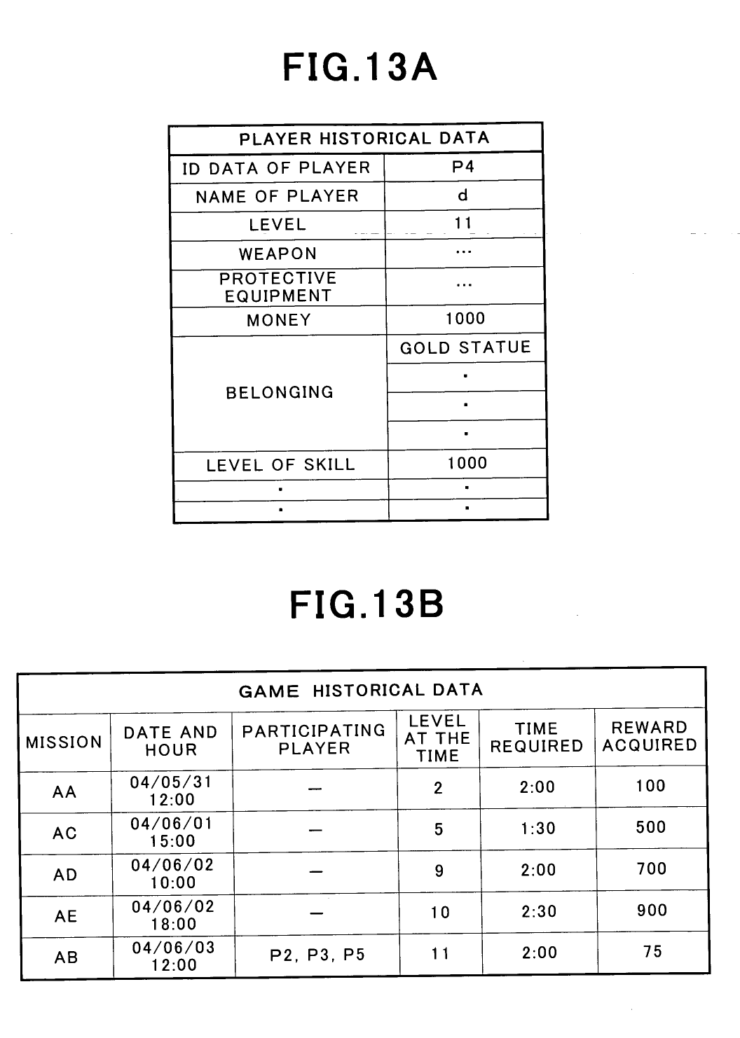

The RAM 203 temporarily stores information in processing, variables, and the like. For example, player participation information (see FIG. 10), player information (see FIG. 14), and the like are stored. Further, when the historical data of the player (see FIGS. 13A and 13B) is supplied from the center server 3, the RAM 203 stores this historical data.

The CPU 201 generates and stores a game history of the player in predetermined time (for example, in time when the player clears the mission, etc) in the RAM 203. The game history generated at this time comprises a plurality of types of elements such as a date and a time (a date and a time when the mission is cleared), player participating in the mission, the level at that point of time, the time required, acquisition of a reward, and the like (see FIGS. 13A and 13B). The player participating in the mission, the level at that point of time, acquisition of a reward, and the like are determined based on the player information stored in the RAM 203 (see FIG. 14). The time required is determined as follows. Specifically, the CPU 201 sets the timer in the RAM 203 when starting the mission, and performs an interruption processing at a predetermined cycle to count up the timer values of the timer sequentially. The CPU 201 then calculates the time required on the basis of the timer values stored in the RAM 203, when the mission is cleared by the player. The date and the time (the date and the time when the mission is cleared) are determined following the time axis in the game in the game system of the present embodiment. The basis of the time axis in the game is an elapsed time which is measured by the center server 3 after provision of a game is started. It should be noted that a current time may be obtained through the Internet at a predetermined cycle to take the actual time axis as the time axis in the game. Furthermore, the actual time axis may be converted using a predetermined conversion formula to obtain the time axis in the game.

The game history for the player is generated each time the mission is cleared, and a plurality of game histories are stored in the RAM 203 of the arcade server 2. After the game is ended, the CPU 201 of the arcade server 2 transmits the plurality of game histories stored in the RAM 203 to the center server 3. A CPU 301 of the center server 3 stores the plurality of game histories received from the arcade server 2 in a RAM 303. The RAM 203 of the arcade server 2 and the RAM 303 of the center server 3 function as game history storing means which can store a plurality of game histories of the player, which comprise a plurality of types of elements. The CPU 201 of the arcade server 2 functions as game history setting means so as to set the game history comprising the plurality of types of elements on the basis of the game result of the player, relating the game history to the time on the game, and store it in the RAM 203 functioning as the game history storing means.

A communication interface circuit 204 is used for transmission of various data with the center server 3 and other arcade server 2 by means of a network such as the Internet or the like. Further, the arcade server 2 comprises an interface circuit group 205, and is connected to a plurality of terminal devices 1 (eight devices here) and a single card machine 6 from the interface circuit group 205 via the dedicated lines 5.

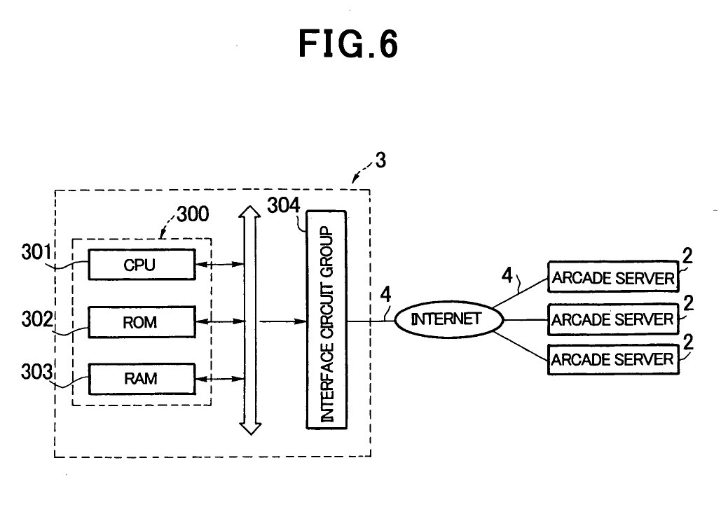

FIG. 6 is a block diagram showing a hardware configuration of the center server. The center server 3 comprises a control portion 300 which controls the overall operation of the center server 3. The control portion 300 comprises a CPU 301, ROM 302 and RAM 303.

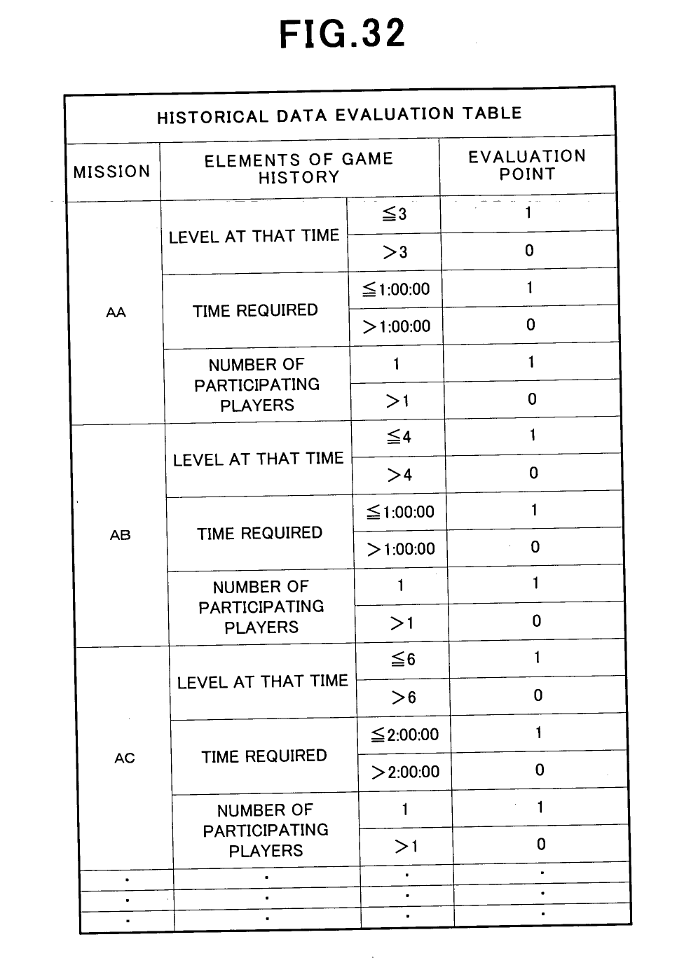

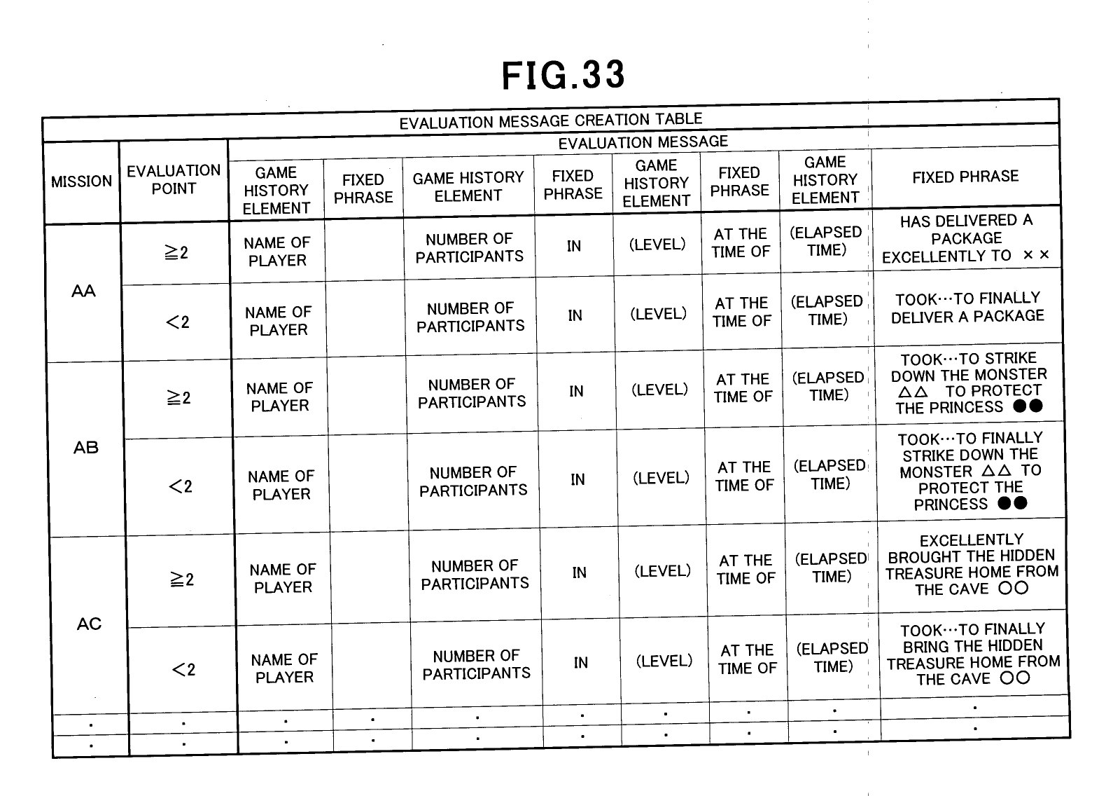

The ROM 302 stores a historical data evaluation table (see FIG. 32) for evaluating the game histories, and an evaluation message creation table (see FIG. 33) for creating an evaluation message. The ROM 302 may be a storage medium embedded in the center server 3, or may be an attachable/detachable storage medium. Further, the both may configure the ROM 302. In addition, among the various data stored in the ROM 302, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

The RAM 303 stores, for example, ID data, historical data (see FIGS. 13A and 13B), a password and the like of the player. The RAM 303 functions as the game history storing means which can store a plurality of game histories of the player, which comprise a plurality of types of elements. The communication interface circuit 304 is used for transmission of various data with the plurality of arcade servers 2 by means of a network such as the Internet or the like.

The CPU 301 refers to the historical data evaluation table stored in the ROM 302 to determine an evaluation point for each game history stored in the RAM 303 which functions as the game history storing means. The evaluation point is used for determining the detail of the evaluation message. If the evaluation point is high, an evaluation message showing a good evaluation is generated, and if the evaluation point is low, an evaluation message showing a bad evaluation is generated.

In addition, the CPU 301 refers to the evaluation message creation table stored in the ROM 302, and uses the above-described evaluation point and the plurality of types of elements configuring the game history to generate the evaluation message for each game history stored in the RAM 303 which functions as the game history storing means. At this time, the CPU 301 functions as evaluation message generating means which uses the plurality of types of elements of the game history to generate the evaluation message for a game result corresponding to the game history, for every game history stored in the RAM 303 as the game history storing means.

Furthermore, the CPU 301 edits the plurality of evaluation messages generated by the CPU 301, which functions as the evaluation message generating means, in accordance with the time axis in the game, and generates an evaluation message group showing the processing of the game of the player. At this time, the CPU 301 functions as evaluation message group generating means. The evaluation message group is obtained by arranging a plurality of evaluation messages along the time axis in the game. The evaluation message group is transmitted to the card machine 6 in predetermined time.

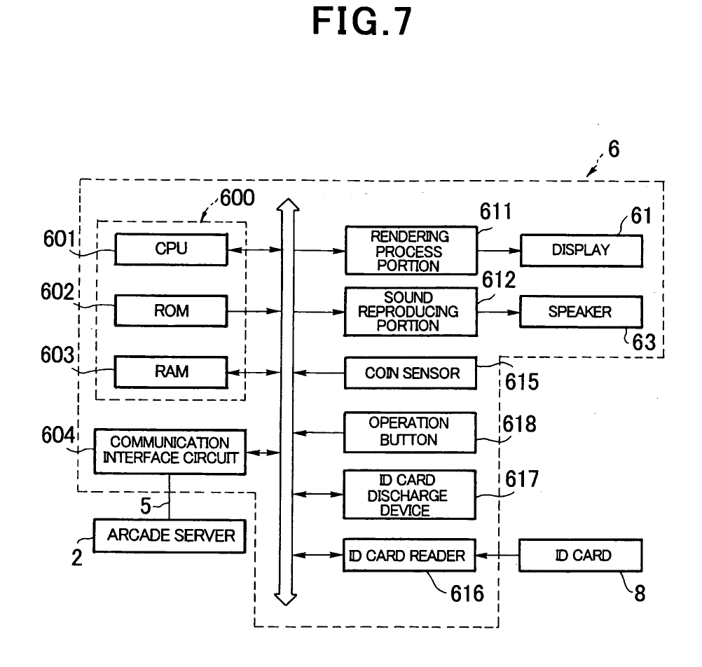

FIG. 7 is a block diagram showing a hardware configuration of the card machine. A control portion 600 is to control the overall operation of the card machine 6, and comprises a CPU 601, ROM 602, and RAM 603.

The ROM 602 stores various image data, programs, and the like such as, for example, image data which configures a biographical image constituted by an evaluation message group, image data which configures an image representing an instruction for purchasing the ID card, and other image data.

The ROM 602 may be a storage medium embedded in the card machine 6, or may be an attachable/detachable storage medium. Further, the both may configure the ROM 602. In addition, among the various data stored in the ROM 602, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

The RAM 603 temporarily stores information in processing, variables, and the like. For example, the RAM 603 stores the historical data (see FIGS. 13A and 13B), evaluation message, biographical data, and the like. This biographical data is equivalent to the evaluation message group of the present invention. The CPU 601 uses an instruction inputted through an operation button 618, or ID data which is read from an ID card reader 616, which is described hereinafter, to transmit to the center server 3 a request signal for requesting the biographical data corresponding to the ID data. The biographical data received from the center server 3 is stored in the RAM 603. A communication interface circuit 604 is used for transmission of the data (for example, the historical data, and the like) with the arcade servers 2 by means of the dedicated lines 5. The rendering process portion 611 displays a biographical image and the like on the display 61, and comprises a VDP (Video Data Processor), a video RAM, and the like. The biographical image is an image obtained by storing the game history for each mission such as the time required when clearing, for example, a mission as a project on a game, as well as the number of enemies struck down in the mission, allocating the evaluation message corresponding to the game history, and editing the allocated evaluation message on the basis of the time axis in the game. Specifically, specific images for the respective missions displayed in the form of a so-called chronological table are attached. A rendering process portion 611 uses the biographical data stored in the RAM 603 to extract various image data configuring a biographical image from the ROM 602, and to store the image data in the video RAM in accordance with priorities displayed on the display 61, thereby generating a biographical image, and outputting it to the display 61. As a result, the biographical image is displayed on the display 61. At this moment, the rendering process portion 611 generates a biographical image representing the biographical data, and functions as biographical image displaying means to display the biographical image.

A sound reproducing portion 613 outputs a predetermined sound, BGM and the like to speakers 63. A coin sensor 615 generates a predetermined signal to the control portion 600 when detecting a coin is inserted into the card machine 6. The operation button 618 comprises a plurality of buttons and is used to input various instructions to the card machine 6. The operation button 618 transmits a detection signal to the control portion 600 when detecting an operation by a player. An ID card discharge device 617 is used to discharge one ID card out of a plurality of ID cards stored in a predetermined place inside the card machine 6, when a predetermined amount of coins and the personal data are inputted into the card machine 6. The ID card reader 616 is used to read out the ID card from the ID card 8 which is inserted into the card machine 6.

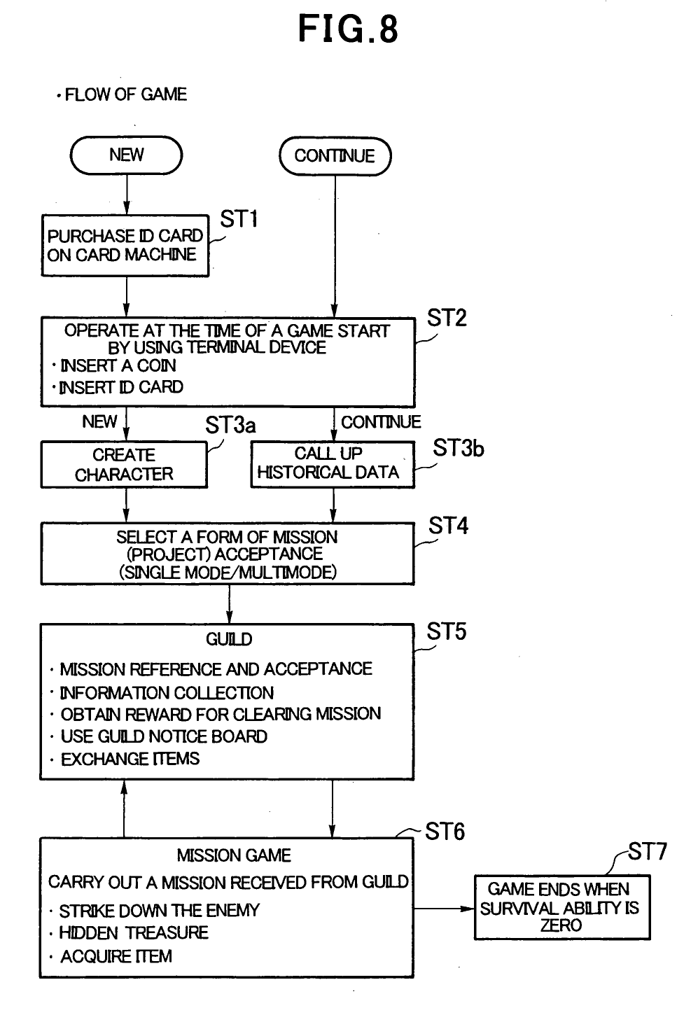

Next, a flow of a game played in the game system of the above-described embodiment is described. FIG. 8 is a figure showing a flow of a game played in the game system of the present embodiment. First of all, a player who tries to play a new game purchases the ID card 8 on the card machine 6 (ST 1). Specifically, the player inserts a predetermined amount of coins into the card machine 6, and inputs the personal data of the player using the operation button 618 (for example, a name or appellation, the date of birth, blood type, constellation, and the like), whereby the ID card 8 is discharged from the ID card discharge device 617. A player who ongoingly plays a game does not have to perform the procedure of ST 1, since he already has the ID card 8.

Next, the player who tries to play a new game or the player who ongoingly plays a game performs an operation at the time of a game start by means of the terminal device 1 (ST 2). The operation at the time of a game start includes, for example, inserting a coin into the coin insertion slot 15, insertion of the ID card 8 into the ID card insertion slot 16, and the like.

When playing a new game after performing the procedure of ST 2, a character is created (ST 3a). Specifically, the player inputs an instruction using the touch panel 14, thereby creating a character according to the preference of the player by selecting an appearance, capability, characteristics and the like of a character corresponding to the player (a character operated by the player). On the other hand, when ongoingly playing a game, since the historical data indicating the game result (see FIGS. 13A and 13B) is stored in the RAM 303 of the center server 3, the historical data is called up from the center server 3 to set the appearance, capability, characteristics and the like of the character at the time of the end of the game (ST 3b).

After finishing the procedure of ST 3 (ST 3a or ST 3b), a form of mission acceptance is selected next (ST 4). A mission is, as described above, accepted from the guild. Either a single mode in which a single player accepts a mission, or a multimode in which a player accepts the mission with other player can be selected. A reward obtained when a mission is cleared is distributed proportionally in accordance with the number of the players who cleared the mission. Therefore, when the single mode is selected, since a single player has to clear a mission, the player can acquire lots of rewards, although the degree of difficulty of the mission is raised. On the other hand, when the multimode is selected, a player can only clear a mission with other player, less reward is acquired, although the degree of difficulty of the mission is lowered.

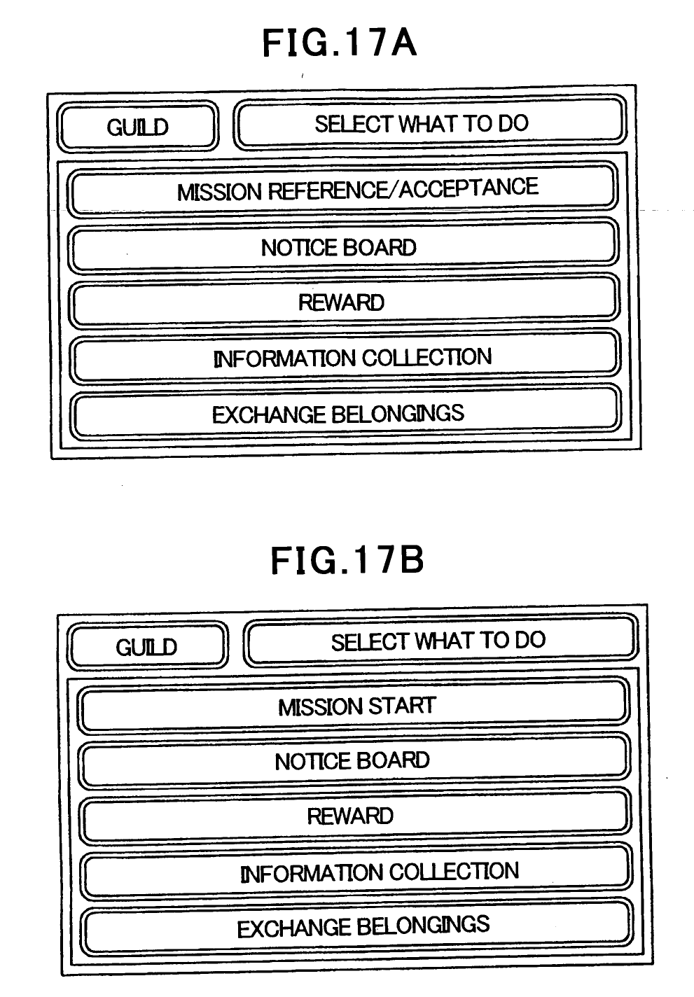

After the procedure of ST 4 is finished, a game is started, and the character corresponding to the player appears in the guild, and can take various actions in the guild (ST 5). In the guild the player can perform, for example, the followings (i) to (v) (see FIGS. 17A and 17B).
(i) Refer to or accept a mission (only before mission acceptance).

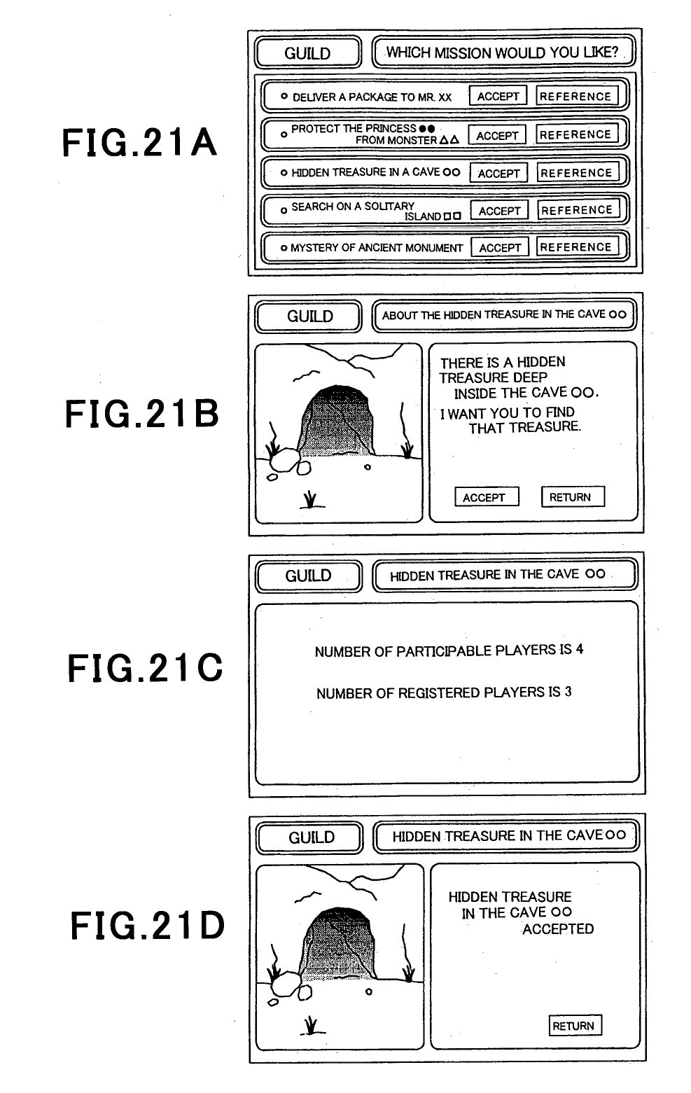

In the present embodiment, for example, there are a plurality of types of missions such as a serious mission and a comical mission (see FIG. 20, FIG. 21A). By selecting a mission that the player is interested in from these missions, the detail of the mission can be referred to (see FIG. 21B). Once the player refers to the mission, understands the detail thereof, and selects to participate therein, the player accepts the mission (see FIG. 21C).
(ii) Collect information on other character or mission.

Information on other character or mission can be obtained in a guild. Particularly, tips for attacking the mission, information on a monster which appears in the virtual game space, and information on an item or the like which can be acquired can be obtained by paying a predetermined amount of money which can be used on the game. For information on other character, it is possible to obtain information on that what kind of character exists in the virtual game space and what kind of adventure the character is involved in. It should be noted that the information which can be obtained in the procedure of (ii) is information which is set beforehand in a program, and not information which can be obtained from other player.
(iii) Obtain a reward for clearing the mission (only when clearing a mission).

Here, an experience value corresponding to the level of a player who clears a mission (a character corresponding to the player), or money which can be used on a game is paid from the guild. However, when a mission is cleared in the multimode, the reward is divided by the number of players who clear the mission.
(iv) Use the notice board.

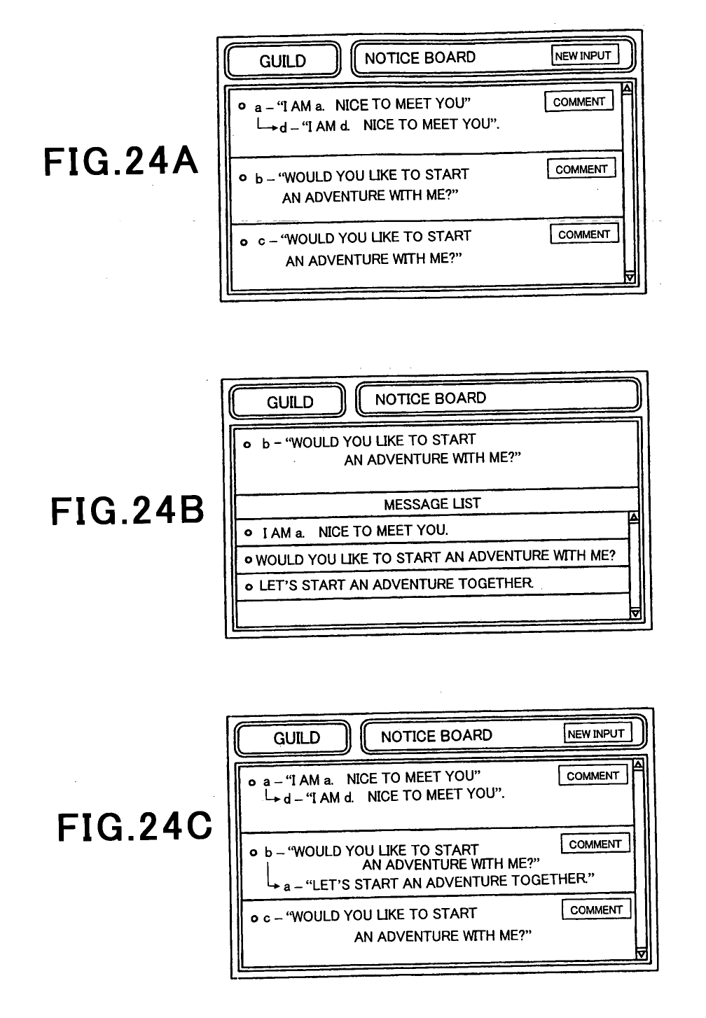

The notice board of a guild can be used by a player to write a message thereon. A message written by each player is displayed on the first display 11 of the terminal device 1 (see FIGS. 24A to 24C). The notice board can be used by the players to exchange the information, where a message is written to other player so that the information on the mission can be exchanged, and that a player can be invited to the mission.
(v) Trade a belonging (an item that the character possesses).

An item that the character acquired in the virtual game space, or an item acquired as a reward for clearing a mission can be traded through the guild.
(vi) Start a mission and move to a mission game (only after mission acceptance)

When the mission is accepted in the above procedure of (i), a transition can be made to a mission game by performing this procedure of (vi).

In the above-described procedure of ST 5, the player can input various instructions by touching an image displayed on the first display 11 by means of the touch panel 14.

In ST 5, when the above-described procedure of (vi) is performed, a transition is made to a mission game (ST 6). The mission game is game in which a mission received from the guild is carried out, and forms the core of the game in the present embodiment. In the mission game of ST 6, a player uses the various buttons 118 and the operation lever 119 to operate the character corresponding to the player, and carry out an adventure in the virtual game space. If the survival ability of the character becomes zero due to an attack from a monster, or the like, the game ends (ST 7).

Furthermore, in the mission game, when a character image representing other character is displayed on the first display 11, a chat button is also displayed on the first display 11. At this time, when touching the chat button by means of the touch panel 14, a chat window is opened, and a plurality of types of chat messages are displayed in the chat window. The player uses the touch panel 14 to touch any one of the chat messages from the plurality of types of chat messages, and thereby can input a chat message. Moreover, by touching the character image representing a character, which is a destination of the chat message, by means of the touch panel 14, the chat message can be transmitted to the terminal device 1 of the player, which operates the character as the destination, via the arcade server 2.

When clearing the mission in ST 6, the player returns to the guild of ST 5, receives a reward for clearing the mission, accepts a new mission, and moves to a mission game again. As described above, the game in the present embodiment is a game which proceeds by carrying out the guild (ST 5) and the mission game (ST 6) alternatively.

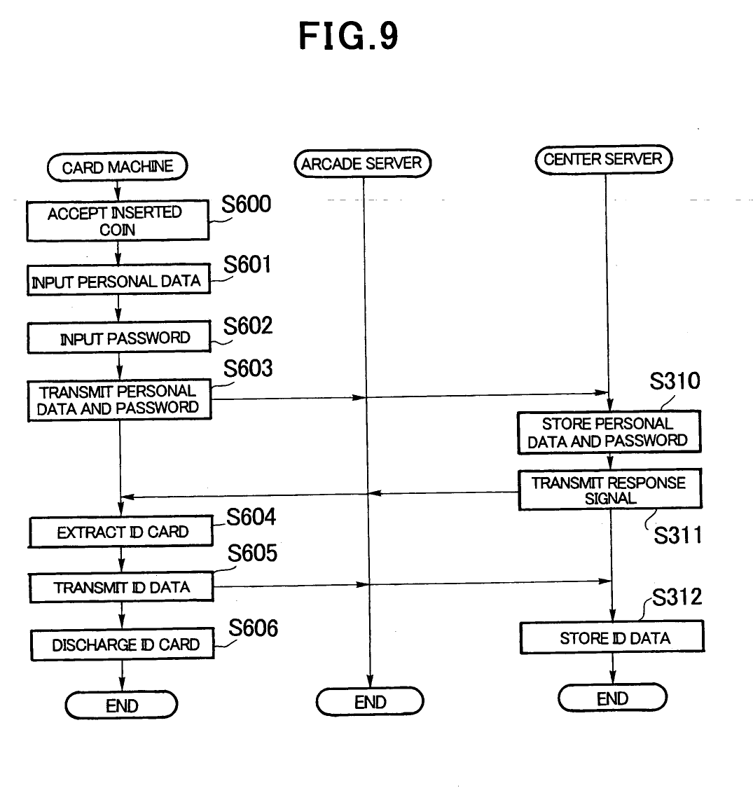

Next, a processing performed in the game system of the present embodiment when proceeding a game as described above is described. FIG. 9 is a flow chart showing a flow of a processing of until an ID card is issued in the card machine 6, arcade server 2 and center server 3.

First of all, the CPU 601 of the card machine 6 accepts that a coin is inserted into the card machine 6 (step S600). When receiving a predetermined signal outputted from the coin sensor 615 when the coin is detected, the CPU 601 accepts an input of the personal data (for example, a name or appellation, the date of birth, blood type, constellation, and the like) by an operation of a player (step S601). The CPU 601 further accepts an input of a password by an operation of the player (step S602). This password is used when authentication of the player is performed by means of the center server 3. Next, the CPU 601 transmits the inputted personal data and password to the center server 3 via the arcade server 2 through the dedicated line 5 by means of the communication interface circuit 604 (step S603).

The CPU 301 of the center server 3 stores the personal data and password transmitted from the terminal device 1 in the RAM 303 (step S310). Accordingly, the player is registered in the center server 3, and the CPU 301 then transmits a response signal to the terminal device 1 (step S311).

The CPU 601 of the card machine 6 extracts one ID card 8 from the plurality of ID cards 8 stored inside the card machine 6 (step S604). The CPU 601 then transmits the ID data stored in the extracted ID card 8 to the center server 3 (step S605), and discharges the ID card 8. As a result, the player can obtain the ID card 8. On the other hand, the center server 3 which receives the ID data relates the ID data to the personal data and password stored in the RAM 303, and thereafter stores it (step S312).

In the game system of the present embodiment, each terminal device 1 and the arcade server 2 connected to the terminal device 1 via the dedicated line 5 exchange data with each other, whereby a game proceeds. The player participation information which is stored in the RAM 203 of the arcade server 2 connected to the each terminal device 1 via the dedicated line 5, and in the RAM 303 of the center server 3 at this moment is described using FIG. 10.

FIG. 10 is a figure showing information on participation of players. Starting from the column on the left, information items on the order of acceptance (RN) which is the order where the center server 3 accepts participation to a game, on a machine ID (CN) which is identification information of the terminal device 1, and on an arcade server symbol (SN) which is identification information of the arcade server 2 are stored. In the game of the present embodiment, a predetermined number of players (20, for example) can participate in the same game, and the situation of the participation of the players is managed by the player participation information shown in FIG. 10.

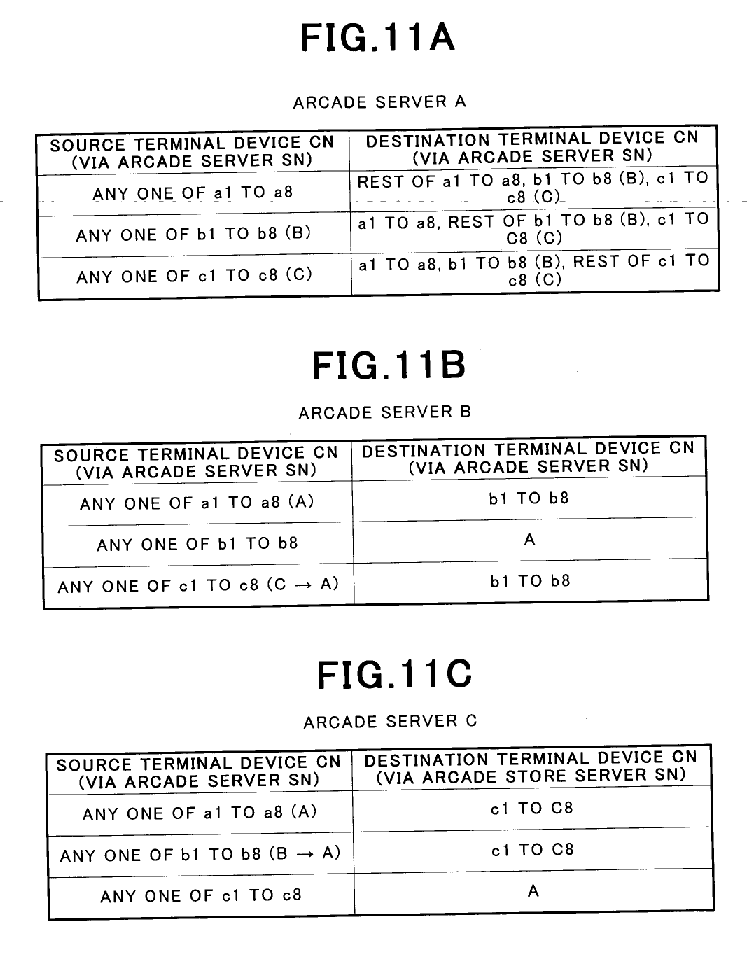

FIGS. 11A to 11C are figures for explaining the detail of a data transmission processing performed by the arcade servers A, B, and C. FIGS. 11A, 11B and 11C are figures for explaining the detail of the processing performed by the arcade servers A, B, and C respectively. The column on the left of the figure lists the machine ID (CN) of the terminal device 1 which is the source of data to be received by the arcade server 2 (arcade server A, B, or C), and the arcade server symbol (SN) of the arcade server 2 through which the data goes through before received by the arcade server 2. The column on the right of the figure lists the machine ID (CN) of the terminal device 1 which is the destination of data to be transmitted from the arcade server 2 (arcade server A, B, or C), and the arcade server symbol (SN) of the arcade server 2 through which the data goes through before received by the terminal device 1. It should be noted that when receiving the data transmitted from the terminal device 1 (for example, the terminal device a1 and the like) participating in a game, the CPU 201 that each arcade server A, B, and C comprises update various data stored in a predetermined region of the RAM 203.

The CPU 201 of the arcade server A receives data from any one of the terminal devices a1 to a8, as shown in the second line from the top of the FIG. 11A, and transmits the data to the rest of the terminal devices a1 to a8 and to the arcade servers B and C. The CPU 201 of the arcade server B then receives the data from any one of the terminal devices a1 to a8 via the arcade server A, as shown in the second line from the top of the FIG. 11B, and transmits the data to terminal devices b1 to b8. The CPU 201 of the arcade server C receives the data from any one of the terminal devices a1 to a8, as shown in the second line from the top of the FIG. 11C via the arcade server A, and transmits the data to terminal devices c1 to c8.

The CPU 201 of the arcade server B receives the data from any one of the terminal devices b1 to b8, as shown in the third line from the top of the FIG. 11B, and transmits the data to the arcade server A. The CPU 201 of the arcade server A then receives the data from any one of the terminal devices b1 to b8 via the arcade server B, as shown in the third line from the top of the FIG. 11A, and transmits the data to the terminal devices a1 to a8, the rest of the terminal devices b1 to b8, and the terminal devices c1 to c8. The CPU 201 of the arcade server C receives the data from any one of the terminal devices b1 to b8 via the arcade servers B and A, as shown in the third line from the top of the FIG. 11C, and transmits the data to the terminal devices c1 to c8.

Similarly, the CPU 201 of the arcade server C receives the data from any one of the terminal devices c1 to c8, as shown in the fourth line from the top of the FIG. 11C, and transmits the data to the arcade server A. The CPU 201 of the arcade server A then receives the data from any one of the terminal devices c1 to c8 via the arcade server C, as shown in the fourth line from the top of the FIG. 11A, and transmits the data to the terminal devices a1 to a8, the terminal devices b1 to b8, and the rest of the terminal devices c1 to c8. The CPU 201 of the arcade server B receives the data from any one of the terminal devices c1 to c8 via the arcade servers C and A, as shown in the fourth line from the top of the FIG. 11B, and transmits the data to the terminal devices b1 to b8.

In this manner, the CPU 201 transmits the data from each of the terminal devices 1 among the arcade servers A, B, and C, whereby the various data stored in the RAM 203 is updated every time the data from each of the terminal devices 1 is accepted. Therefore, each of the terminal devices 1 uses the data stored in the RAM 203 to proceed with the game, whereby the temporal synchronization in the proceeding of the game (matching the proceeding state of the game) can be controlled easily among the terminal devices 1.

Specifically, the arcade server 2 (the arcade server A here) which initially accepts participation to a game receives the data from the terminal device 1 connected by the dedicated line 5, transmits the data to all the other terminal devices 1, at the same time receives the data from the terminal device 1, which is connected to the other arcade server 2 (the arcade server B or C here) via the dedicated line 5, through the abovementioned other arcade server (the arcade server B or C), and transmits the data to all the other terminal devices 1. Further, the abovementioned other arcade server 2 (the arcade server B or C) receives the data from the terminal device 1, which is connected via the dedicated line 5, through the arcade server 2 (the arcade server A), and transmits the data to the terminal device 1 connected via the dedicated line 5.

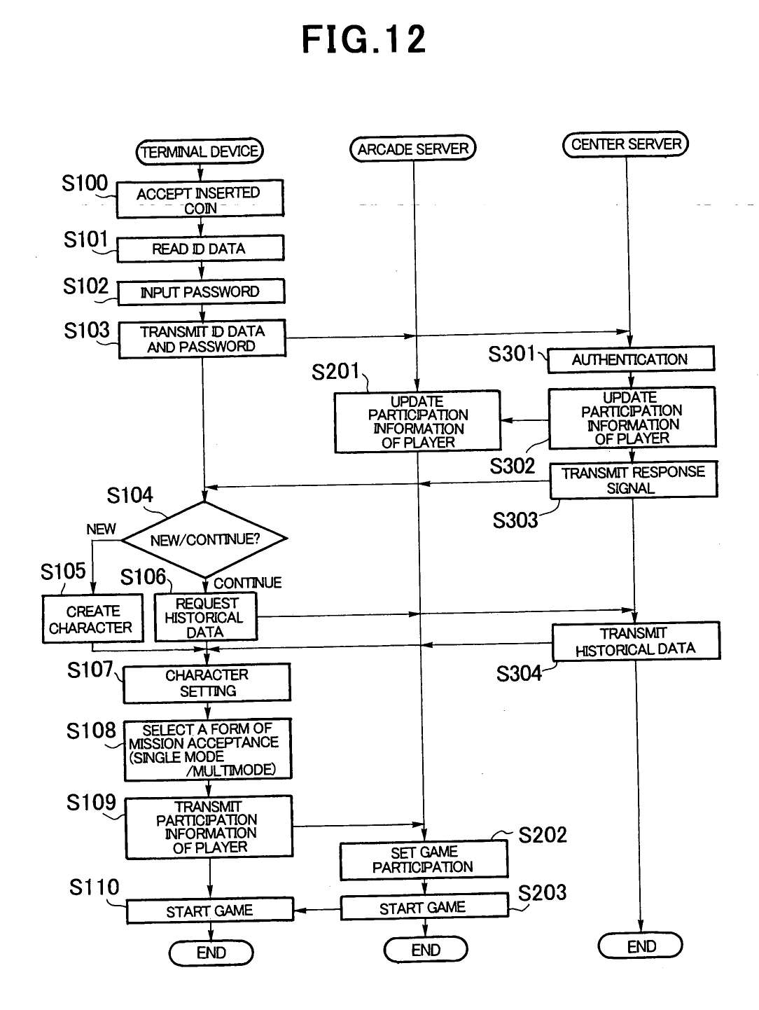

FIG. 12 is a flow chart showing a flow of processings of until a game start in the terminal device 1, arcade server 2 and center server 3. First, the CPU 101 of the terminal device 1 accepts that a coin is inserted into the coin insertion slot 15 (step S100). When receiving a predetermined signal outputted from the coin sensor 115 when the coin is detected, the CPU 101 reads the ID data of the player from the ID card 8 inserted into the ID card insertion slot 16, by means of the ID card reader 116 (step S101). Next, the CPU 101 accepts an input of a password by an operation of the player (step S102). The CPU 101 then transmits the read ID data and the password inputted by the operation of the player to the center server 3 through the arcade server 2 via the dedicated line 5 by means of the communication interface circuit 104 (step S1103).

The CPU 301 of the center server 3 determines whether or not the ID data, which is received from the terminal device 1, exists in the ID data stored in the RAM 303, and, when it is determined that the ID data exists, performs authentication by determining whether the password of the player, which is related to the ID data and stored in the RAM 303, matches the password received from the terminal device 1 (step S301). It should be noted that the CPU 301 refers to the historical data stored in the RAM 303, and determines whether the player is one who tries to play a new game or one who ongoingly plays the game.

The CPU 301 of the center server 3 then updates the player participation information stored in the RAM 303 (see FIG. 10) (step S302), and transmits the player participation information to the arcade server 2 to update the player participation information stored in the RAM 203 of the arcade server 2 (step S201). Next the CPU 301 of the center server 3 transmits an authentication result as a response signal to the terminal device 1 (step S303).

The CPU 101 of the terminal device 1 determines whether the player who starts a game is one who plays a new game or one who ongoingly plays the game, on the basis of the response signal received from the center server 3 (step S1104).

In the step S104, when it is determined that the player who stars a game is one who tries to play a new game, the CPU 101 performs creation of a character on the basis of an operation of the player (step S105). In this processing, the player uses the touch panel 14 while viewing the image display on the first display 11, to input instructions for selecting an appearance, capability, characteristics and the like of a character corresponding to the player (character operated by the player), and the CPU 101 creates a character corresponding to the instructions. The CPU 101 then generates information on the player and player information (see FIG. 14) comprising a plurality of items such as a capability value of the character corresponding to the player based on the result of the processing in the step S105, and thereby performs character setting (step S107). It should be noted that the player information shown in FIG. 14 indicates player information related to all of the players participating in the game, and the player information generated in this processing only indicates a predetermined item for one player.

In the step S104, on the other hand, when it is determined that the player who starts a game is one who ongoingly plays the game, the CPU 101 transmits a signal for requesting the historical data of the player to the center server 3 via the dedicated line 5 by means of the communication interface circuit 104 (step S106). Once the center server 3 receives the signal from the terminal device 1, the center server 3 reads out the historical data for the player from the RAM 303, and transmits the historical data to the terminal device 1 (step S304).

FIGS. 13A and 13B are figures showing an example of the historical data. The historical data shown in FIG. 13A is historical data of the player and the character at that moment (also referred to as “player historical data” hereinafter). The historical data shown in FIG. 13B is historical data indicating the game process of the player (character corresponding to the player) (also referred to as “game historical data” hereinafter). These historical data are updated in a predetermined time (for example, a time when a mission is cleared, when receiving a reward for clearing a mission, when a monster is struck down, etc.).

The player historical data includes items such as, for example, the ID data of the player, the name of the player, the level, weapons, protective equipment, belongings of the character, the pocket money, the level of skill, and the like, as shown in FIG. 13A. Furthermore, as shown in FIG. 13B, the game historical data includes, for every mission cleared by the player, a plurality of historical data items comprising a plurality of types of elements such as the date and hour when the mission is cleared, the player participating in the mission, the level when the mission is cleared, the time required, a reward acquired, and the like.

In the step S304, such historical data shown in FIG. 13 is transmitted from the center server 3 to the terminal device 1. The CPU 101 of the terminal device 1, which receives the historical data from the center server 3, uses the historical data to generate the information on the player and the player information comprising a plurality of items such as the capability value of the character corresponding to the player (see FIG. 14), and thereby performs the character setting (step S107). Regarding the capability value of the character, the CPU 101 refers to the capability value setting value table stored in the ROM 102 to determine the capability value of the character, on the basis of the level of the player (character corresponding to the player) included in the historical data. It should be noted that the player information shown in FIG. 14 indicates player information related to all of the players participating in the game, and the player information generated in this processing only indicates a predetermined item for one player.

After the processing of the step S107 is performed, the CPU 101 accepts that a form of mission acceptance is selected (step S108). In this processing, the player operates the touch panel 14 while viewing the image display on the first display 11, to input instructions for selecting either the single mode in which a single player accepts a mission, or a multimode in which a player accepts the mission with other player. The CPU 101 stores data corresponding to the inputted instructions in the column for the form of mission acceptance of the player information stored in the RAM 103 (see FIG. 14). It should be noted that the player information shown in FIG. 14 indicates player information related to all of the players participating in the game, and the data stored in the column for the form of mission acceptance in this processing is data of a single player only.

Next, the CPU 101 transmits the player information on one player, which is stored in the RAM 103, to the arcade server 2 via the dedicated line 5 by means of the communication interface circuit 104 (step S109).

Next, the CPU 201 of the arcade server 2 uses the player information related to the single player to perform settings for allowing the player to participate in the game (step S202). In this processing, the CPU 201 adds the player information related to the single player, the player information being received from the terminal device 1, to the player information which is already stored in the RAM 203. Moreover, the CPU 201 sets a play field coordinates of the character corresponding to a player who newly participates in the game to an initial value (a value corresponding to the location of the guild) (see FIG. 14).

FIG. 14 shows the player information stored in the RAM 203 of the arcade server 2. As shown in FIG. 14, player information on a plurality of players (five players in the figure) is stored in the RAM 203 of the arcade server 2. The player information comprises a plurality of items, and, for example, information on the player, level of the character, capability value, information on the level of skills, and other items are stored, for example. As shown in the figure, information on a mission in the course of setting is stored in the column for the mission. Further, data regarding whether the single mode is selected or the multimode is selected is stored in the column for the form of mission acceptance. In addition, data regarding the position in the virtual game space in which the character exists at the moment is stored in the play field coordinates.

After the processing of the step S202 is executed, a game is started in the terminal device 1 and in the arcade server 2 (steps S110, S203). As shown in FIG. 12, each player can participate in the game played in the game system according to the present embodiment whenever the player wants, and a plurality of players can play the same game in the same virtual game space. This is one of the characteristics of the MMORPG. Moreover, during the game, the data is transmitted between the arcade server 2 and each of the terminal devices 1 participating in the game, and the temporal synchronization is controlled as described above using FIG. 11, thus the same player information is always stored in the RAM 203 of the arcade server 2 and the RAM 103 of the terminal device 1.

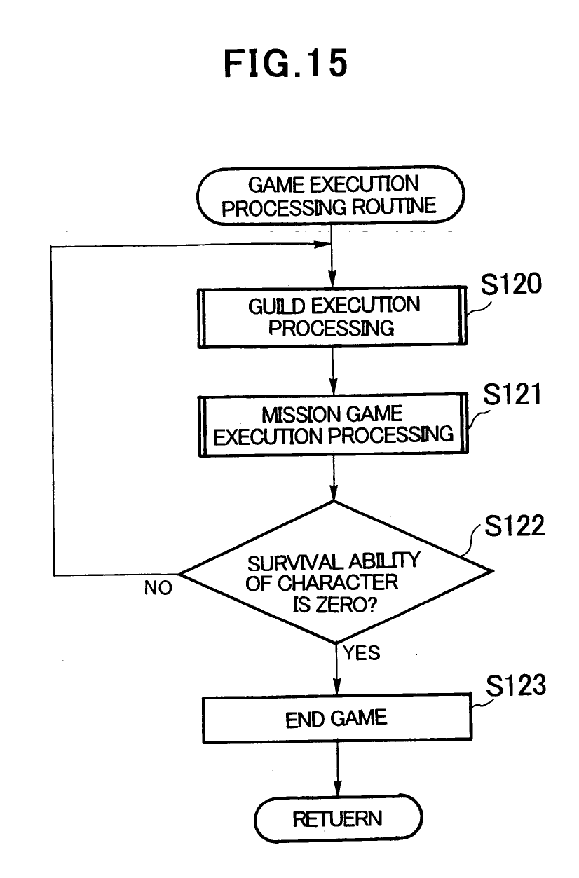

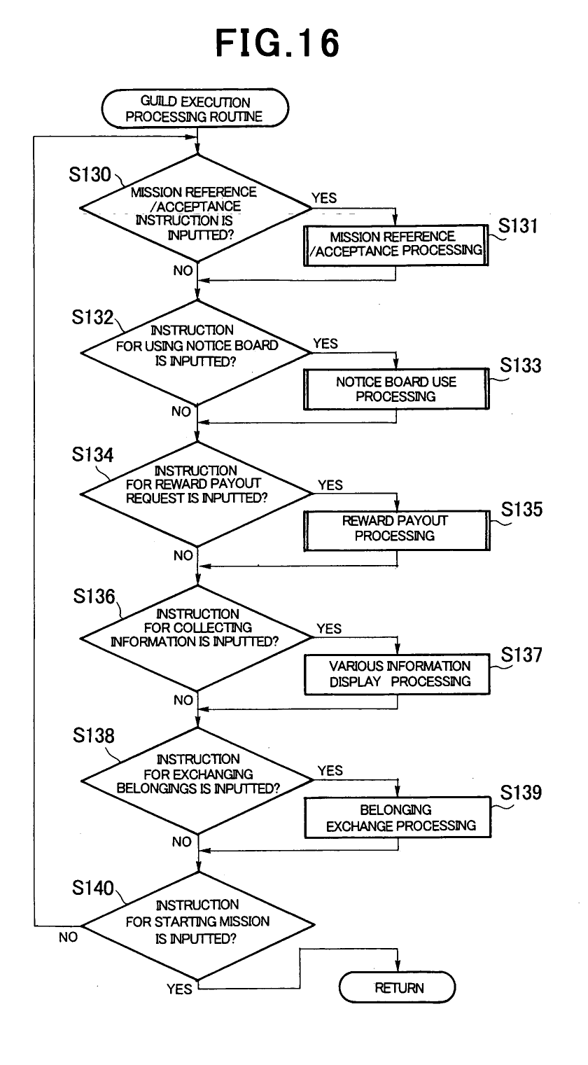

FIG. 15 is a flow chart showing an outline of the processing executed in the terminal device 1 during a game. First of all, the CPU 101 of the terminal device 1 performs a guild execution processing (step S120). In the guild execution process, which is explained hereinafter using FIG. 16, mission reference and acceptance, information collection, reception of a reward for clearing a mission, use of the guild notice board or exchange of the items, and the like can be performed, as shown in ST 5 of FIG. 8. Moreover, the guild execution processing ends when a character accepts a mission and thereafter the mission is started.

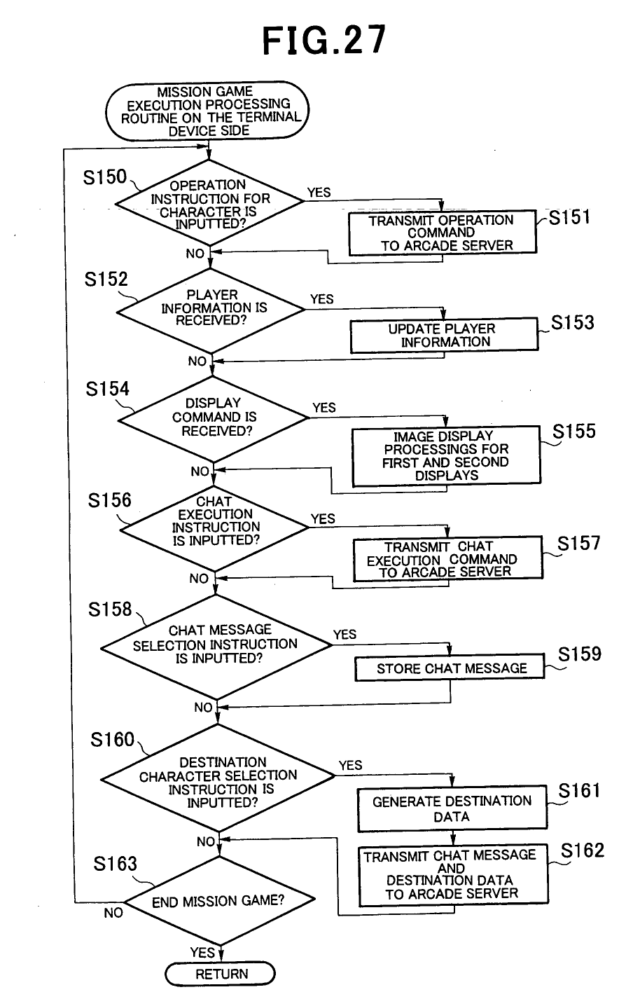

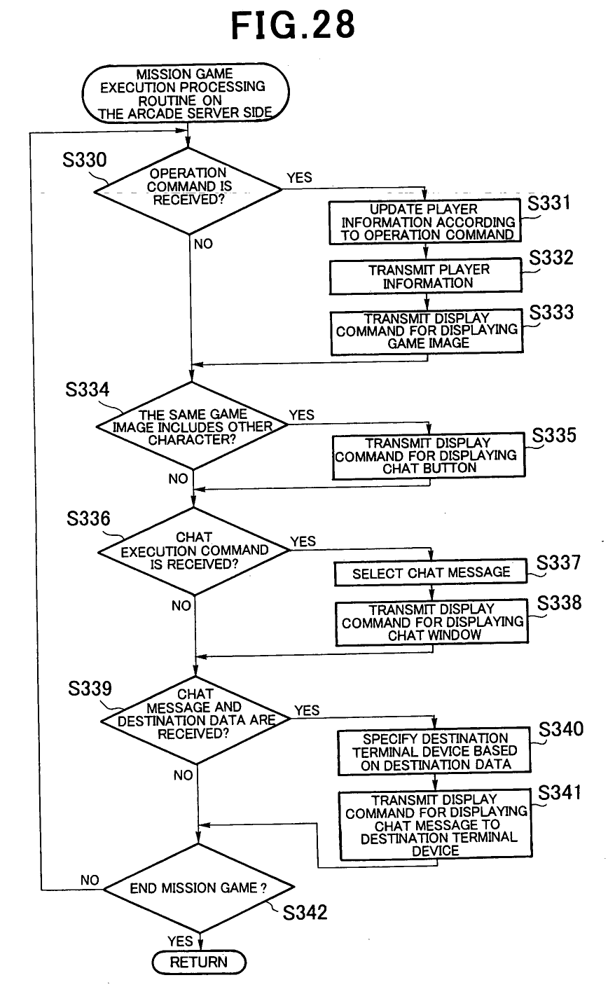

After the guild execution processing of the step S120 ends, the CPU 101 performs a mission game execution processing (step S121). The mission game execution processing is described hereinafter using FIG. 27 and FIG. 28. In the mission game execution processing, a player uses the various buttons 118 and the operation lever 119 to operate the character corresponding to the player, and carries out an adventure in the virtual game space. The player can also exchange a chat message with other player. This mission game execution processing ends when a predetermined condition for mission termination is satisfied. The condition for mission termination includes, for example, clearing a mission, returning to the guild, and reaching zero survival ability, and the like.

In the case where the condition for mission termination as described is satisfied, and the mission game execution processing of the step S121 ends, the CPU 101 determines whether or not the survival ability of the character becomes zero (step S122). When it is determined that the survival ability of the character becomes zero, the character cannot continue the game, thus various processings for ending the game are executed (step S123), and the sub routine is ended. When the game ends, the CPU 201 of the arcade server 2 transmits the game history stored in the RAM 203 to the center server 3. The center server 3 stores the game history received from the arcade server 2 in the RAM 303.

In the step S122, on the other hand, when it is determined that the survival ability of the character is not zero, it means that other conditions for mission termination (for example, clearing the mission, returning to the guild, and the like) are satisfied. Thus the processing is returned to the guild execution processing of the step S120. Therefore, in this game execution processing, the guild execution processing of the step S120 and the mission game execution processing of the step S121 are repeatedly executed until the survival ability of the character becomes zero. Of course, although not shown, when an instruction for ending the game is inputted by the player, the sub routine is ended after executing the processing of the step S123 for ending the game, regardless of whether the survival ability of the character is zero or not.

Next, the guild execution processing which executed after called up in the step S120 of the flow chart shown in FIG. 15 is described. FIG. 16 is a flow chart showing a routine of the guild execution processing which is called up in the step S120 of the flow chart shown in FIG. 15 and is executed by the terminal device 1. FIGS. 17A and 17B are figures schematically showing images which are displayed on the first display 11 of the terminal device 1 when the sub routine shown in FIG. 16 is executed.

When the guild execution processing shown in FIG. 16 is executed, an image as shown in FIG. 17A is displayed on the first display 11 by the first rendering process portion 111. An image such as “guild” which shows the current location of the character is disposed on the upper left of the screen, and an image showing an instruction for the player such as “please select what to do” is disposed on the upper right of the screen. An image showing options such as “mission reference/acceptance”, “notice board”, “reward”, “information collection”, “exchange of the belongings” are disposed from the top in the center of the screen. The player can input an instruction corresponding to the options by touching the image showing the selection using the touch panel 14.

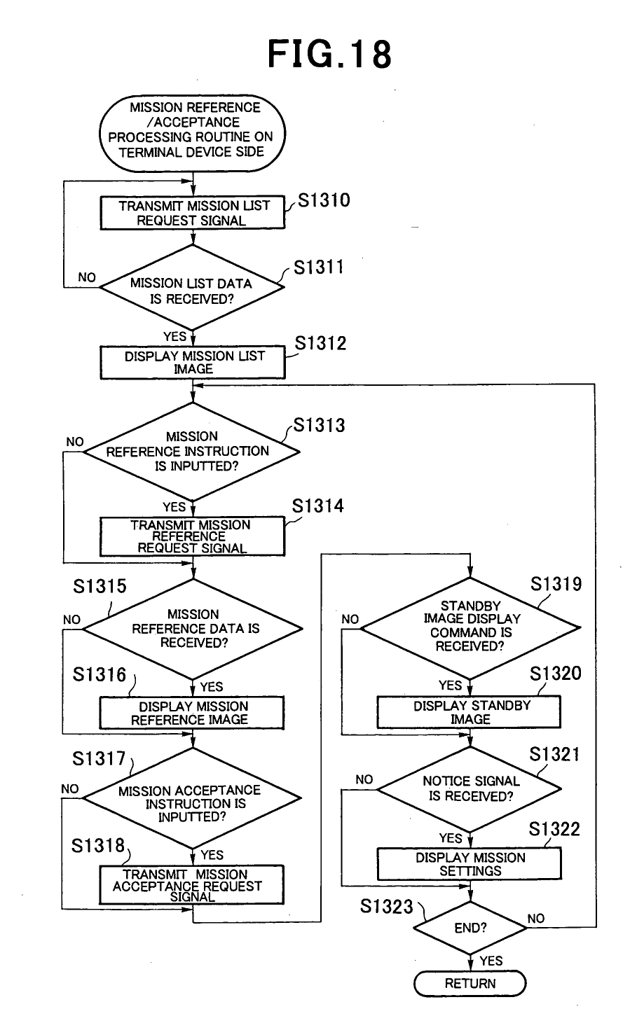

Once the sub routine shown in FIG. 16 is executed, the CPU 101 first determines whether an instruction for the mission reference/acceptance is inputted or not (step S130). The player inputs this instruction by touching the image showing the option of “mission reference/acceptance” by means of the touch panel 14. When it is determined that the instruction for the mission reference/acceptance is inputted, the CPU 101 executes the mission reference/acceptance processing (step S131). This mission reference/acceptance processing is described in detail hereinafter using FIG. 18. As shown in FIG. 17B, the option of “mission reference/acceptance” displayed on the first display 11 is changed to an option of “mission start”.

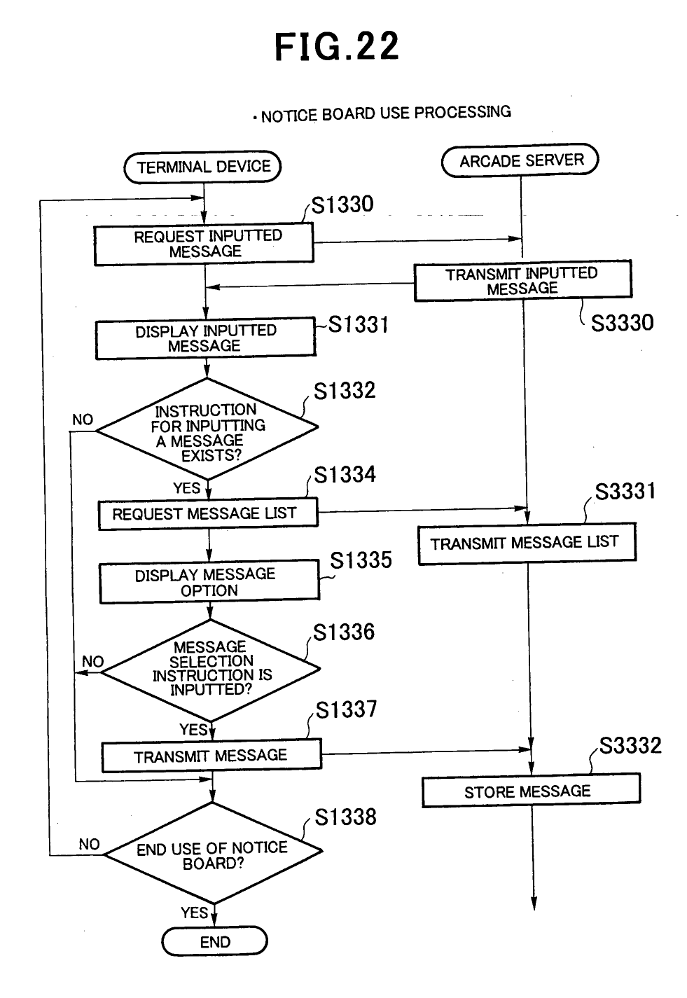

Next, the CPU 101 determines whether an instruction for using the notice board is inputted or not (step S132). The player inputs this instruction by touching the image showing the option of “notice board” by means of the touch panel 14. When it is determined that the instruction for using the notice board is inputted, the CPU 101 executes a notice board use processing (step S133). This notice board use processing is described in detail hereinafter using FIG. 22.

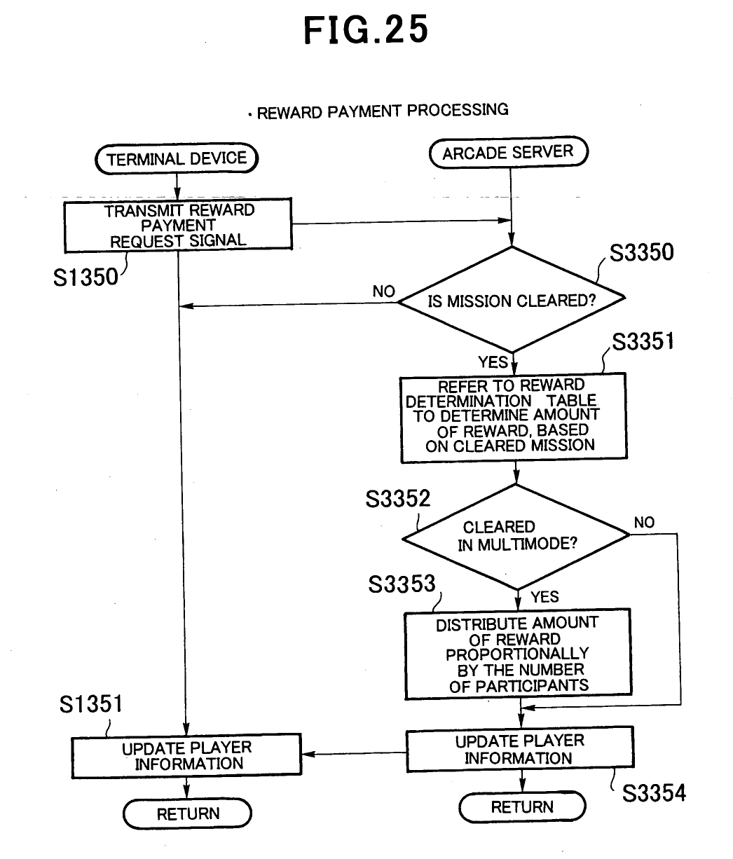

Next, the CPU 101 determines whether an instruction for a reward payout request is inputted or not (step S134). The player inputs this instruction by touching the image showing the option of “reward” by means of the touch panel 14. When it is determined that the instruction for a reward payout request is inputted, the CPU 101 executes a reward payout processing (step S135). This reward payout processing is described in detail hereinafter using FIG. 25.

Next, the CPU 101 determines whether an instruction for collecting information is inputted or not (step S136). The player inputs this instruction by touching the image showing the option of “information collection” by means of the touch panel 14. When it is determined that the instruction for information collection is inputted, various information display processings are performed (step S137). In the processings, the CPU 201 of the arcade server 2 executes the programs stored in the ROM 202, whereby the CPU 101 acquires the information selected from the ROM 203 (for example, the information related to other character or mission) from the arcade server 2, and, based on this information, displays an image representing this information on the first display 11 by means of the first rendering process portion 111.

Next, the CPU 101 determines whether an instruction for exchanging the belongings is inputted or not (step S138). The player inputs this instruction by touching the image showing the option of “exchange of the belongings” by means of the touch panel 14. When it is determined that the instruction for exchanging the belongings is inputted, a belonging exchange processing is performed (step S139). In this processing, when the player selects a belonging which the player wishes to sell to the guild from among the belongings of the character, the instruction is transmitted to the arcade server 2, and the CPU 201 of the arcade server 2 increases the money for the player information stored in the RAM 203, and performs a processing for deleting the data of the belonging. On the other hand, when the player selects an item sold by the guild, the instruction is transmitted to the arcade server 2, and the CPU 201 of the arcade server 2 reduces the pocket money for the player information stored in the RAM 203, and performs a processing for adding the data for the item.

Next, the CPU 101 determines whether the instruction for starting mission is inputted or not (step S140). The player inputs this instruction by touching the image showing the option of “mission start” by means of the touch panel 14, when the image shown in FIG. 17B is displayed on the first display 11. When it is determined that the instruction for the mission start is inputted, the sub routine ends. On the other hand, when it is determined that the instruction for the mission start is not inputted, the processing is returned to the step S130.

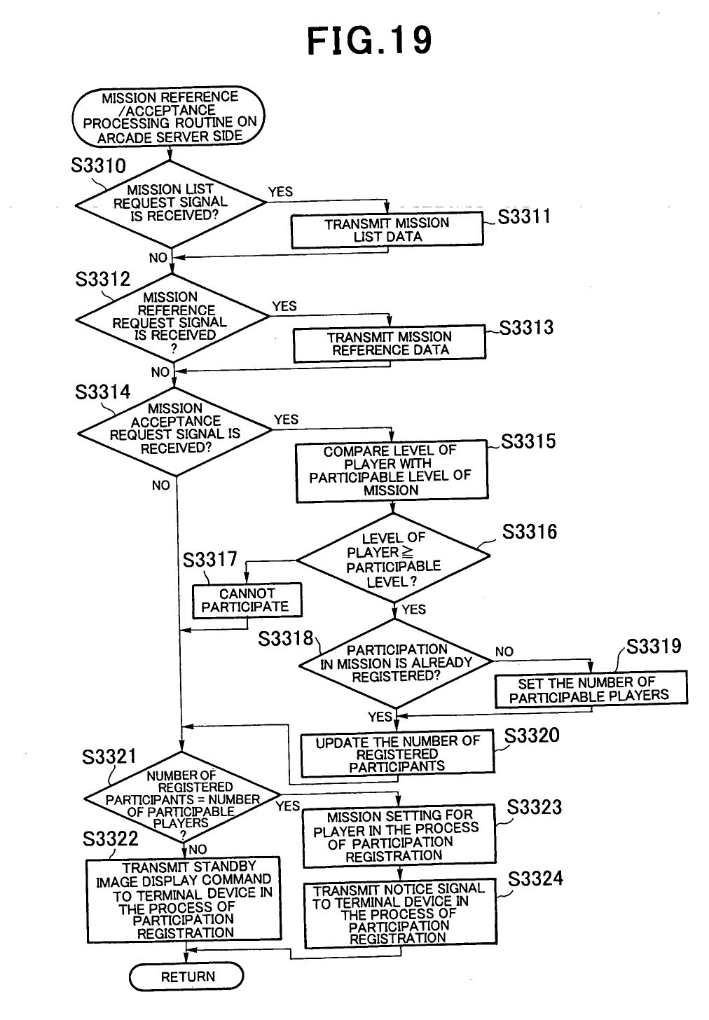

FIG. 18 is a flow chart showing a routine of the mission reference/acceptance processing which is called up in the step S131 of the flow chart shown in FIG. 16 and executed by the terminal device 1. FIG. 19 is a flow chart showing a processing executed by the arcade server 2 in accordance with the sub routine shown in FIG. 18, which is executed by the terminal device 1.

First of all, the CPU 101 of the terminal device 1 transmits a mission list request signal to the arcade server 2 via the dedicated line 5 by means of the communication interface circuit 104 (step S1310). This processing corresponds to a processing of a step S3310 of FIG. 19, where when the CPU 201 of the arcade server 2 receives the mission list request signal from the terminal device 1, the CPU 201 extracts mission list data, which is related to a mission in which the player can participate at the present moment, from the mission list data stored in the ROM 202, and transmits it to the terminal device 1.

FIG. 20 is a figure showing an example of the mission list data. Mission codes (for example, “AA”, “AB”, and the like) comprising two-digit symbols are stored in the leftmost column, the mission codes being allocated to the missions respectively. Further, the number of participable players in each mission is stored in the right column thereof. “1” is stored as the number of participable players for the single mode, and “4” is stored as the number of participable players for the multimode.

In the present embodiment, there is provided an explanation of the case where the number of participable players for the single mode is 1 and the number of participable players for the multimode is 4. The present invention, however, is not limited to this example. For example, a mission where the number of participable players for the single mode is 0 may exist. In this case, a player cannot participate in this mission by the single mode, thus the multimode has to be selected. The number of participable players for the multimode is also not particularly restricted.

The detail of the mission “AA” is “wishing to deliver a package to Mr. XX”, and the participable level is 1. It should be noted that the participable level is the minimum level necessary for accepting the mission, and if the player does not reach the level, he cannot accept the mission. The detail of the mission “AB” is “wishing to protect the Princess ●● from monster ΔΔ”, and the participable level is 3. The detail of the mission “AC” is “wishing to search for a hidden treasure in a cave OO”, and the participable level is 5. The detail of the mission “AD” is “wishing to search for a hidden treasure on a solitary island □□”, and the participable level is 7. The detail of the mission “AE” is “wishing to search the ancient monument to solve the mystery of ▪▪”, and the participable level is 9. The detail of the mission “AF” is “searching a land no man has ever explored”, and the participable level is 11. The degree of difficulty of the mission becomes high in the order of “AA” to “AF”, and the participable level is so as to be higher in accordance with the degree of difficulty of the mission. The mission (condition) in the present invention is not limited to this example, of course, and is not particularly restricted as long as it can be set in a game.

After the processing of the step S1310, the CPU 101 determines whether or not the mission list data is received from the arcade server 2 (step S1311). When it is determined that the mission list data is not received, the processing is returned to the step S1310. On the other hand, when it is determined that the mission list data is received from the arcade server 2, the CPU 101 controls the first rendering process portion 111, and performs a processing for causing the first display 11 to display the image shown in FIG. 21A (step S1312).

FIG. 21A is a figure showing an example of an image displayed on the first display 11 when the processing of the step S1312 is performed. An image such as “guild” which shows the current location of the character is disposed on the upper left of the screen, and an image showing an instruction for the player, such as “which mission would you like?”, is disposed on the upper right of the screen. An image showing the details of the mission is displayed, such as “deliver a package to Mr. XX”, “protect the Princess ●● from monster ΔΔ”, “a hidden treasure in a cave OO”, “search on a solitary island □□”, and “mystery of an ancient monument” sequentially from the top in the center of the screen. An image showing options of “reference” and “acceptance” is disposed in accordance with each mission. The player can touch the image showing the options by means of the touch panel 14 to input an instruction corresponding to the options. For example, by touching the image showing the option of “reference” corresponding to “a hidden treasure in a cave OO” by means of the touch panel 14, information on “a hidden treasure in a cave OO” can be obtained. Further, by touching the image showing the option of “acceptance” corresponding to “a hidden treasure in a cave OO” by means of the touch panel 14, the mission “a hidden treasure in a cave OO” can be accepted.

After the processing of the step S1312, the CPU 101 determines whether or not an instruction of the mission reference is inputted (step S1313). This instruction can be inputted by touching the image showing the option of “reference” by means of the touch panel 14. When it is determined that an instruction of the mission reference is inputted, the CPU 101 transmits a mission reference request signal to the arcade server 2 via the dedicated line 5 by means of the communication interface circuit 104 (step S1314). This processing corresponds to a step S3312 of FIG. 19. The arcade server 2 which receives the mission reference request signal from the terminal device 1 extracts the mission reference data related to the mission requested from the mission reference data stored in the ROM 202 (for example, the data in which the detail of the mission is described, a dynamic image or static image showing the detail, and the like), and transmits the extracted mission reference data to the terminal device 1.

When it is determined in the step S1313 that an instruction for the mission reference is not inputted, or when the processing of the step S11314 is executed, the CPU 101 then determines whether or not the mission reference data is received (step S1315). When it is determined that the mission reference data is received, the CPU 101 controls the first rendering process portion 111, and performs a processing for causing the first display 11 to display the image shown in FIG. 21B (step S1316).

FIG. 21B is a figure showing an example of an image displayed on the first display 11 when the processing of the step S1316 is performed. An image such as “guild” which shows the current location of the character is disposed on the upper left of the screen, and an image showing the name of the mission to be referred to, such as “about a hidden treasure in a cave OO”, is disposed on the upper right of the screen. An image showing an entrance of the cave OO is disposed on the left side of the screen. On the right side of the screen, an image showing a message for explaining the detail of the mission is disposed, and also an image showing options of “acceptance” and “return” is disposed.

When it is determined in the step S1315 that the mission reference data is not received from the arcade server 2, or when the processing of the step S1316 is executed, the CPU 101 determines whether or not an instruction for the mission acceptance is inputted (step S1317). This instruction can be inputted by touching the image showing an option of “acceptance” by means of the touch panel 14. When it is determined that an instruction for the mission acceptance is inputted, the CPU 101 transmits a mission acceptance request signal to the arcade server 2 via the dedicated line 5 by means of the communication interface circuit 104 (step S1318). This processing corresponds to the processing of the step S3314 of FIG. 19.

In the step S1317, when it is determined that an instruction for the mission acceptance is not inputted, or when the processing of the step S1318 is executed, the CPU 101 determines whether or not a standby image display command is received from the arcade server 2 (step S1319). This processing corresponds to the processing of a step S3322 of FIG. 19, and the standby image display command comprises data related to the number of participable players to the mission and to the number of registered participants.

In he step S1319, when it is determined that the standby image display command is received, the CPU 101 controls the first rendering process portion 111 on the basis of the standby image display command (step S1320). The first rendering process portion 111 uses the data related to the number of participable players and to the number of registered participants contained in the above-described standby image display command to extract predetermined image data from the ROM 102, and arcade the image data in the video RAM in the predetermined order of priority, thereby generating a standby image. The first rendering process portion 111 then outputs the standby image to the first display 11. As a result, the image shown in FIG. 21C, for example, is displayed on the first display 11.

FIG. 21C is a figure showing an example of an image displayed on the first display 11 when the processing of the step S1320 is performed. An image such as “guild” which shows the current location of the character is disposed on the upper left of the screen, and an image showing the name of the mission, such as “a hidden treasure in a cave OO”, is disposed on the upper right of the screen. Further, in the center of the screen, an image is displayed showing that the number of participable players is 4, and that the number of registered participants at the present moment is 3.

In the step S1319, when it is determined that the standby image display command is not received from the arcade server 2, or when the processing of the step S1320 is executed, the CPU 101 then determines whether or not a notice signal is received from the arcade server 2 (step S1321). This processing corresponds to he processing of a step S3324 of FIG. 19.

When it is determined in the step S1321 that the notice signal is received, the CPU 101 controls the first rendering process portion 111, and causes the first display 11 to display an image showing that the mission is set, as shown in FIG. 21D (step S1322).

FIG. 21D is a figure showing an example of an image displayed on the first display 11 when the processing of the step S1322 is performed. An image such as “guild” which shows the current location of the character is disposed on the upper left of the screen, and an image showing the name of the accepted mission, such as “a hidden treasure in a cave OO”, is disposed on the upper right of the screen. An image showing an entrance of the cave OO is disposed on the left side of the screen. On the right side, an image showing that the mission is accepted is disposed.

When it is determined in the step S1321 that the notice signal is not received, or when the processing of the step S1322 is executed, the CPU 101 determines whether or not to end the mission reference/acceptance processing (step S1323). The mission reference/acceptance processing ends when the player uses the touch panel 14 to input an instruction for returning the processing to the sub routine of FIG. 16 after ending this processing. In the step S1323, when it is determined to end the mission reference/acceptance processing, the sub routine ends. On the other hand, when it is determined not to end the mission reference/acceptance processing, the processing is moved to the step S1313.

Next, the flow chart shown in FIG. 19 is described. First of all, the CPU 201 of the arcade server 2 determines whether or not a mission list request signal is received from the terminal device 1 (step S3310). This processing corresponds to the processing of the step S1310 of FIG. 18. When it is determined that the mission list request signal is received from the terminal device 1, the CPU 201 of the arcade server 2 extracts the mission list data related to a mission in which the player can participate at the present moment, from the mission list data stored in the ROM 202, and transmits it to the terminal device 1 (step S3311). This processing corresponds to the step S1311 of FIG. 18, where a mission list image (see FIG. 21A) is displayed on the first display 11 of the terminal device 1 which receives the mission list data (FIG. 18, step S1312).

In the step S3310, when it is determined that the mission list request signal is not received, or when the processing of the step S3311 is executed, the CPU 201 of the arcade server 2 determines whether or not a mission reference request signal is received from the terminal device 1 (step S3312). This processing corresponds to the processing of the step S1314 of FIG. 18.

When it is determined in the step S3312 that the mission reference request signal is received from the terminal device 1, the CPU 201 extracts the mission reference data related to the mission requested from the mission reference data stored in the ROM 202, and transmits the extracted mission reference data to the terminal device 1 (step S3313). This processing corresponds to the step S1315, where a mission reference image (see FIG. 21B) is displayed on the first display 11 of the terminal device 1 which receives the mission reference data (FIG. 18, step S1316).

In the step S3312, when it is determined that the mission reference request signal is not received, or when the processing of the step S3313 is executed, the CPU 201 determines whether or not a mission acceptance request signal is received (step S3314). This processing corresponds to the step S1318 of FIG. 18.

When it is determined in the step S3314 that the mission acceptance request signal is received, the CPU 201 of the arcade server 2 compares the level of the player, which is contained in the player information stored in the RAM 203 (see FIG. 14), with the participable level contained in the mission list data stored in the ROM 202 (see FIG. 20) (step S3315). Next, the CPU 201 determines whether the level of the player is above the participable level of the mission, on the basis of the comparison result in the step S3315 (step S3316). For example, for a player “d” in the player information shown in FIG. 14, since the level is 11, and the player can participate in the mission “AB” in which the participable level is 3. On the other hand, for a player “a” in the player information shown in FIG. 14, since the level is 1, the player cannot participate in the mission “AB”.

When it is determined in the step S3316 that the level of the player is not above the participable level of the mission, the CPU 201 moves the processing to the step S3321 without performing registration for participation of the player to the mission (step S3317).

On the other hand, in the step S3316, when it is determined that the level of the player is above the participable level of the mission, the CPU 201 determines whether or not other player already performs registration for participation to the mission (step S3318). If it is determined that the abovementioned other player does not perform the registration for participation to the mission, the CPU 201 refers to the mission list data stored in the ROM 202, and stores in the RAM 203 the data related to the number of participable players for the mission, thereby setting the number of participable players to the mission (step S3319). For example, if the player selects the single mode, the RAM 203 is caused to store the data indicating that the number of participable players is “1”. Furthermore, if the player selects the multimode, the RAM 203 is caused to store the data indicating that the number of participable players is “4”.

In the step S3318, when it is determined that the other player already performs the registration for participation to the mission, or when the processing of the step S3319 is executed, the CPU 201 performs a processing for updating the number of registered participants (step S3320). When the processing of the step S3319 is executed, the CPU 201, in this processing, stores in the RAM 203 the data indicating that the number of participants for the mission is “1”. On the other hand, when the other player already performs the registration for participation to the mission, the CPU 201, in this processing, updates the number of participants stored in the RAM 203 so as to add 1 to the number of participants, since the data indicating the number of participants for the mission is stored in the RAM 203.

In the step S3314, when it is determined that the mission acceptance request signal is not received, or when the processing of the step S3320 is executed, the CPU 201 determines whether or not the number of participants for a mission, in which the number of participants is updated (by adding 1) sequentially every time when the processing of the step S3320 is performed, is the same as the number of participants for the mission which is set in the step S3319 (step S3321). When the single mode is selected, the number of participable players for the mission is set to “1” in the step S3319, and the number of registered participants for the mission is stored as “1” in the RAM 203 in the step S3320, thus the determination in the step S3321 is “YES”. Further, when the multimode is selected, the number of participable players is set to “4” in the step S3319, and the number of registered participants for the mission is stored as “1” in the RAM 203 in the step S3320, thus the determination in the step S3321 is “NO”. The processing of the step S3320 is repeated thereafter, and when the number of registered participants for the mission is “4”, the determination in the step S3321 is

When it is determined in the step S3321 that the number of registered participants is not the same as the number of participable players, the CPU 201 of the arcade server 2 transmits a standby image display command containing the data related to the number of registered participants and to the number of participable players to the terminal device 1 in the process of participation registration (step S3322). This processing corresponds to the processing of the step S1319 of FIG. 18, where a standby image (see FIG. 21C) is displayed on the first display 11 of the terminal device 1 which receives the standby image display command (FIG. 18, step S1320). Thereafter the sub routine ends.

On the other hand, when it is determined in the step S3321 that the number of registered participants is the same as the number of participable players, the CPU 201 of the arcade server 2 updates the data for the player information on the column for mission (see FIG. 14), the player information being stored in the RAM 203, and allows the player, who is in the process of participation registration, to set the mission (step S3323). Next, the CPU 201 transmits a notice signal indicating that the mission is set to the terminal device 1 in the process of participation registration (step S3324). This processing corresponds to the processing of the step S1321 of FIG. 18, where an image (see FIG. 21D) showing that the mission is set is displayed on the first display 11 of the terminal device 1 which receives the notice signal (FIG. 18, step S1322). Thereafter the sub routine ends.

FIG. 22 is a flow chart showing a notice board use processing which is called up in the step S133 of the flow chart shown in FIG. 16 and is executed by the terminal device 1, and a processing executed by the arcade server 2 in accordance with the abovementioned processing. FIG. 23 is a figure showing an example of a message list which is used when the processing of the step S1334 on the flow chart shown in FIG. 22 is performed.

First, the CPU 101 of the terminal device 1 transmits request signal for requesting an inputted message to the arcade server 2 (step S1330). Once the arcade server 2 receives this request signal, the arcade server 2 transmits a message which is already inputted by the terminal device 1 and stored in the RAM 203 (inputted message), to the terminal device 1 which is the source of the request signal (step S3330).

Once the terminal device 1 receives the inputted message from the arcade server 2, the terminal device 1 displays an image showing the inputted message shown in FIG. 24A on the first display 11 by means of the first rendering process portion 111 (step S1331).

FIG. 24A is a figure showing an example of an image displayed on the first display 11 of the terminal device 1 when the processing of the step S1331 of FIG. 22 is executed. An image such as “guild” which shows the current location of the character is disposed on the upper left of the screen, and an image such as “notice board” is disposed on the upper right of the screen. An image for showing an option such as “new input” is disposed on the right side. “New input” is not for inputting a message for the message of other player, but is an option used when inputting a new message. The player uses the touch panel 14 to touch the image of “new input”, and thereby can input an instruction for inputting a new message.

An inputted message which is inputted by each player is displayed in the center of the screen. For example, an image, “a—‘I am a. Nice to meet you’”, indicates a message, “I am a. Nice to meet you,” inputted by the player “a”. Further, an image for showing an option such as “comment” is disposed on the right side. “Comment” is not for inputting a new message, but is an option used when inputting a message to the message of the other player. The player uses the touch panel 14 to touch the image of “comment”, and thereby can input an instruction for inputting a message to the other player. Moreover, an image disposed right below the abovementioned message, such as “d—‘I am d. Nice to meet you’”, indicates a message, “I am d. Nice to meet you,” inputted by the player “d” in response to the message of the player “a”. An image such as “b—‘Would like to start an adventure with me’”, and an image such as “c—‘Would like to start an adventure with me’” are disposed on the lower side of the message of the player “d”. These are messages inputted by the player “b” and “c” to look for a player who can participate in the mission together.

After the processing of the step S1331, the CPU 101 determines whether or not an instruction for inputting a message is inputted (step S1332). The player can input the instruction for inputting a message by touching the image of “new input” or “comment” by means of the touch panel 14.

When it is determined in the step S1332 that the instruction for inputting a message is inputted, the CPU 101 of the terminal device 1 transmits a request signal for requesting a message list to the arcade server 2 (step S1334). The CPU 201 of the arcade server 2 receiving this request signal extracts the message list stored in the ROM 202, and transmits it to the terminal device 1 which is the source of the request signal (step S3331).

FIG. 23 is a figure showing an example of the message list. Message numbers are stored on the left column, and messages corresponding to the respective numbers are stored on the right column. For example, a message, “I am ‘a (name of a player)’. Nice to meet you”, is related to the number “001”. Further, a message “Would you like to start an adventure with me?”, is related to the number “002”. Furthermore, a message “Let's start an adventure together”, is related to the number “003”. Although not shown in the figure, a lot of other messages are stored in this message list.

The CPU 101 of the terminal device 1 which receives the message list from the arcade server 2 controls the first rendering process portion 111 on the basis of the message list, and performs a processing for displaying, on the first display 11, a message option in which any one message can be selected out of a plurality of messages (step S1335).

FIG. 24B is an image displayed on the first display 11 when the player “a” uses the touch panel 14 to input an instruction for inputting a message to a message of the player “b”, when the image shown in FIG. 24A is displayed on the first display 11. An image such as “guild” which shows the current location of the character is disposed on the upper left of the screen, and an image such as “notice board” is disposed on the upper right of the screen. There is disposed on the lower side thereof an image showing a message of the player “b” to which the player “a” inputs a message. Moreover, on the lower side of the image showing the message of the player “b”, a message list in which a plurality of options showing messages are listed vertically. When the image shown in FIG. 24B is displayed, the player uses the touch panel 14 to touch the image representing a message that the player wishes to input, and thereby can input an instruction for transmitting the message to the arcade server 2.

After the processing of the step S1335, the CPU 101 determines whether or not an instruction for selecting a message is inputted (step S1336). This instruction can be inputted by touching any one option of the plurality of options showing message by means of the touch panel 14, when the image shown in FIG. 24B is displayed on the first display 11.

When it is determined in the step S1336 that the instruction for selecting a message is inputted, the CPU 101 transmits the message to the arcade server 2 via the dedicated line 5 by means of the communication interface circuit 104 (step S1337). On the other hand, once receiving the message from the terminal device 1, the CPU 201 of the arcade server 2 causes the RAM 203 to store the message (step S3332). Here, the message stored in the RAM 203 is exchanged between the terminal device 1 and the arcade server 2 in the abovementioned step S1330, S1331, or S3330, and becomes a message displayed on the first display 11 of the terminal device 1, in other words, the inputted message.

The CPU 101 of the terminal device 1 thereafter determines whether to end the notice board use processing (step S1338). The notice board use processing ends when the player uses the touch panel 14 to input an instruction for returning the processing to the sub routine of FIG. 16 after ending this processing. When it is determined in the step S1338 to end the notice board use processing, the sub routine ends. On the other hand, when it is determined not to end the notice board use processing, the processing is returned to the step S1330. Then, the CPU 101 again transmits the request signal for requesting the inputted message (step S1330). The arcade server 2 receiving the request signal transmits the inputted message to the terminal device 1 (step S3330). The terminal device 1 receiving the inputted message from the arcade server 2 then displays the inputted message on the first display 11 (step S1331).

FIG. 24C is an image displayed on the first display 11 of the terminal device 1 when the player uses the touch panel 14 to touch an image of “let's start an adventure together”, when the image shown in FIG. 24B is displayed on the first display 11. Unlike the image shown in FIG. 24A, the image shown in FIG. 24C is displayed with an additional message of “let's start an adventure together”, which is inputted by the player “a” to the message of the player “b”.

FIG. 25 is a flow chart showing a reward payment processing which is called up in the step S135 of the flow chart shown in FIG. 16 and is executed by the terminal device 1, and a processing executed by the arcade server 2 in accordance with the abovementioned processing. First of all, the CPU 101 of the terminal device 1 transmits a reward payment request signal to the arcade server 2 (step S1350). Once receiving the reward payment request signal from the terminal device 1, the CPU 201 of the arcade server 2 uses the player information stored in the RAM 203 (see FIG. 14) to determine whether or not the player clears the mission (step S3350). When it is determined in the step S3350 that the player clears the mission, the CPU 201 of the arcade server 2 refers to a reward determination table to determine the amount of reward, based on the cleared mission (step S3351).

FIG. 26 is a figure showing an example of the reward determination table. Mission codes comprising two-digit symbols are stored in the left column of the reward determination table, and amount of rewards corresponding to the mission codes are stored in the right column of the same. For example, the amount of reward corresponding to the mission “AA” is 100, and the amount of reward corresponding to the mission “AB” is 300.

After the processing of the step S3351, the CPU 201 refers to the player information stored in the RAM 203 (see FIG. 14), and determines whether or not the player clears the mission in the multimode (step S3352). When it is determined that the mission is cleared in the multimode, the amount of reward determined in the step S3351 is distributed proportionally in accordance with the number of participants in the msison (step S3353). For example, when four players participate in the mission “AA”, the amount of reward is 25.

In the step S3352, when it is determined that the player clears the mission in the single mode instead of the multimode, or when the processing of the step S3353 is executed, the CPU 201 updates the player information stored in the RAM 203 (see FIG. 14) (step S3354). Specifically, the data in the column for the mission is cleared, and the amount of money is increased by the amount of reward. The CPU 101 of the terminal device 1 synchronize the player information updated in the arcade server 2 to update the player information (step S1351).

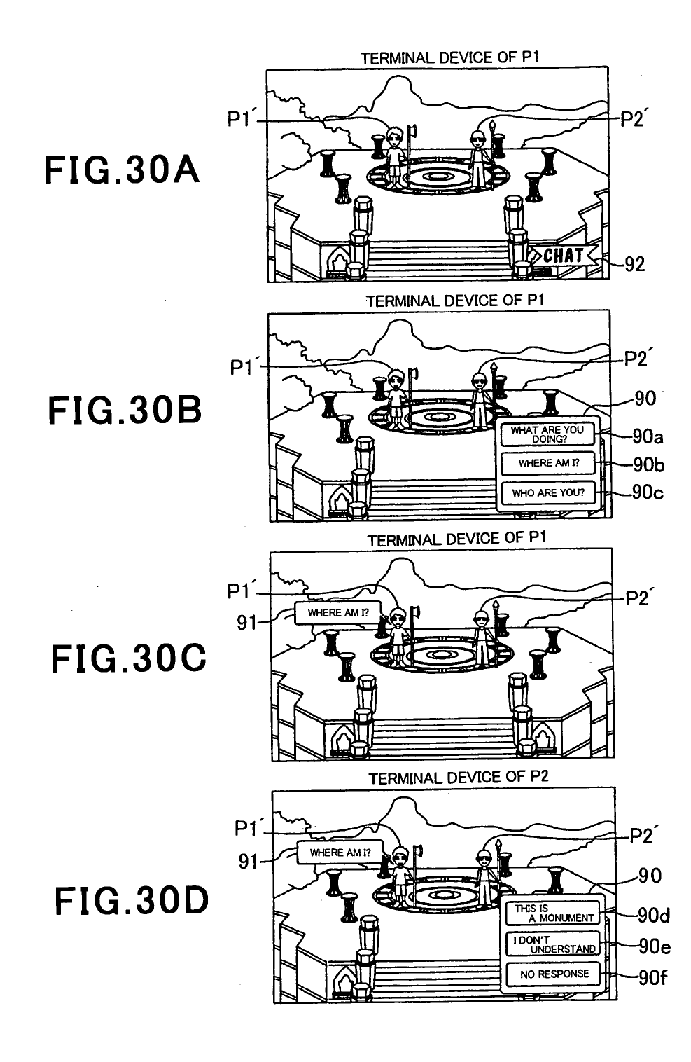

A mission game is now described next. FIG. 27 is a flow chart showing a routine of a mission game execution processing which is called up in the step S121 of the flow chart shown in FIG. 15 and is executed by the terminal device 1. FIG. 28 is a flow chart showing a processing executed by the arcade server 2 in accordance with the sub routine shown in FIG. 27, which is executed by the terminal device 1. FIG. 29 is a figure showing an example of a chat message list. FIGS. 30A to 30D are figures showing an example of images which are displayed on the first display 11 of the terminal device 1 by executing the processings shown in FIG. 27 and FIG. 28.

First, the CPU 101 of the terminal device 1 determines whether or not an operation instruction for a character is inputted (step S150). The player can input the operation instruction for a character by operating the various buttons 118 or the operation lever 119. When the operation instruction for a character is inputted, the CPU 101 transmits an operation command to the arcade server 2 (step S151). This processing corresponds to a step S330 in FIG. 28.

In the step S150, when it is determined that the operation instruction for a character is not inputted, or when the processing of the step S151 is executed, the CPU 101 determines whether or not the player information is received from the arcade server 2 (step S152). This processing corresponds to a step S332 of FIG. 28. When it is determined that the player information is received, the CPU 101 updates the player information stored in the RAM 103 on the basis of the abovementioned player information (step S153).

In the step S152, when it is determined that the player information is not received from the arcade server 2, or when the processing of the step S153 is executed, the CPU 101 determines whether or not a display command is received from the arcade server 2 (step S154). This processing corresponds to a step S333, S335, S338, or S341 in FIG. 28.

When it is determined in the step S154 that the display command is received, the CPU 101 executes the image display processing for the first display 11 or the second display 12 (step S155). In this processing, the CPU 101 supplies the display command to the first rendering process portion 111 or the second rendering process portion 112. The first rendering process portion 111 refers to the player information stored in the RAM 103 (see FIG. 14) according to the abovementioned display command, and extracts the image data from the ROM 102. Then, by storing the video data in the video RAM in accordance with the order of priority displayed on the first display 11 (in the order of a background image, monster image, and character image, for example), the first rendering process portion 111 generates a game image, and outputs it to the first display 11. As a result, the game image is displayed on the first display 11.

Also, when displaying the game image three dimensionally, the first rendering process portion 111 performs calculation for converting the object (for example, an object configuring a character or monster, and the like) stored in the ROM 102 from a position on the three dimensional space to a position on a pseudo three dimensional space, light source calculation processing, and the like, as well as a write processing of the image data (for example, mapping of the texture data for the region of the video RAM specified with a polygon) to be rendered to the video RAM on the basis of the results of the above calculations, thereby generating the game image, and outputs it to the first display 11. As a result, the three-dimensional game image is displayed on the first display 11. The second rendering process portion 112 extracts a predetermined image from the ROM 102 in accordance with the abovementioned display command. Then, by storing the video data in the video RAM in accordance with the order of priority displayed on the second display 12, the second rendering process portion 112 generates a predetermined image, and outputs it to the second display 12. As a result, the predetermined image is displayed on the second display 12.

In the step S154, when the display command for displaying the game image is received from the arcade server 2 (FIG. 28, step S333), the processing of the step S155 is performed, whereby the game image is displayed in the first display 11 (see FIG. 30A). The image shown in FIG. 30A is displayed on the first display 11 of the terminal device 1 operated by a player “P1”, and a character image P1′ corresponding to the player “P1” and a character image P2′ corresponding to a player “P2” are disposed.

Furthermore, in the step S154, when the display command for displaying a chat button is received from the arcade server 2 (FIG. 28, step S335), the processing of the step S155 is performed, whereby a chat button 92 is displayed on the first display 11 (see FIG. 30A). A chat button 92 such as “CHAT” is disposed on the lower right of the image shown in FIG. 30A. The player inputs an instruction for performing chatting by touching the chat button 92 by means of the touch panel 14.

In the step S154, when the display command for displaying the chat window is received from the arcade server 2 (FIG. 28, step S338), the processing of the step S155 is performed, whereby a chat window 90 having three chat messages 90a to 90c is displayed on the first display 11 (see FIG. 30B). The chat window 90 having the three chat messages 90a to 90c such as “What are you doing?”, “Where am I?”, and “Who are you?” respectively is disposed on the lower right of the image shown in FIG. 30B. The player can select a chat message that the player wishes to transmit by touching any one of the chat messages by means of the touch panel 14. Thereafter the player “P1” transmits the selected chat message to the terminal device 1 of the player “P2” by touching the character image P2′ corresponding to the player “P2” by means of the touch panel 14.

In the step S154, when the display command for displaying a chat message is received from the arcade server 2 (FIG. 28, step S341), the processing of the step S155 is performed, whereby a chat message 91 is displayed on the first display 11 (see FIGS. 30C and 30D). The image shown in FIG. 30C is the first display 11 of the terminal device 1 operated by the player “P1” when the chat message 90b is selected by means of the touch panel 14 when the image shown in FIG. 30B is displayed. The chat message 91 such as “Where am I?” is displayed in the vicinity of the character image P1′ corresponding to the player “P1”. Here, the image shown in FIG. 30D is displayed on the first display 11 of the terminal device 1 which is the destination of the chat message and is operated by the player “P2”. The chat message 91 such as “Where am I?” is displayed in the vicinity of the character image P1′ corresponding to the player “P1”. Further, the chat window 90 having three chat messages 90d to 90f such as “This is a monument”, “I don't understand”, and “No response” respectively is displayed on the lower right of the screen.

In the step S154, when it is determined that the display command is not received, or when the processing of the step S155 is executed, the CPU 101 determines whether or not an instruction for performing chatting is inputted (step S156). The player can input this instruction by touching the chat button 92 by means of the touch panel 14. When it is determined that the instruction for performing chatting is inputted, the CPU 101 transmits a chat execution command to the arcade server 2 (step S157). This processing corresponds to a step S336 of FIG. 28.

In the step S156, when it is determined that the instruction for performing chatting is not inputted, or when the processing of the step S157 is executed, the CPU 101 determines whether or not an instruction for selecting a chat message is inputted (step S158). The player can input this instruction by touching any one of the chat messages 90a to 90c included in the chat window 90, by means of the touch panel 14.

When it is determined in the step S158 that the instruction for selecting a chat message is inputted, the CPU 101 stores the selected chat message in the RAM 103 (step S159). In the step S158, when it is determined that the instruction for selecting a chat message is not inputted, or when the processing of the step S159 is executed, the CPU 101 determines whether or not an instruction for selecting a character as the destination of a chat message is inputted (step S160). The player can input this instruction by touching the character image P2′ by means of the touch panel 14.

When it is determined in the step S160 that the instruction for selecting a destination character is inputted, the CPU 101 stores destination data indicating the terminal device 1 which is the destination of a chat message in the RAM 103 (step S161). The CPU 101 then transmits the chat message stored in the RAM 103 and the destination data to the arcade server 2 (step S162).

In the step S160, when it is determined that the instruction for selecting a destination character is not inputted, or when the processing of the step S162 is executed, the CPU 101 refers to the player information stored in the RAM 103 (see FIG. 14), and determines whether or not a predetermined condition for mission termination is satisfied (step S163). The condition for mission termination includes, for example, clearing a mission, returning to the guild, and reaching zero survival ability, and the like.

When it is determined that the mission game is not ended, the processing is moved to the step S150. On the other hand, when it is determined that the mission game is ended, the sub routine ends.

The processing of the arcade server 2 is explained. First, the CPU 201 determines whether or not an operation command is received from the terminal device 1 (step S330). When it is determined that the operation command is received, the CPU 201 updates the player information stored in the RAM 203 in accordance with the operation command (step S331), and transmits the player information to the terminal device 1 (step S332). This processing corresponds to the step S152 of FIG. 27.

The CPU 201 then transmits a display command for displaying a game image on the first display 11 of the terminal device 1 to the terminal device 1 on the basis of the player information (step S333). This processing corresponds to the step S154 of FIG. 27.

In the step S330, when it is determined that the operation command is not received, or when the processing of the step S333 is executed, the CPU 201 refers to the player information, and determines whether or not a game image displayed on the first display 11 of the terminal device 1 includes other character (step S334). When it is determined that other character is included, the CPU 201 transmits a display command for displaying a chat button to the arcade server 2 (step S335). This processing corresponds to the step S154 of FIG. 27.

In the step S334, when it is determined that the same game image does not include other character, or when the processing of the step S335 is executed, the CPU 201 determines whether or not a chat execution command is received (step S336). This processing corresponds to the step S157 of FIG. 27. When it is determined that the chat execution command is received, the CPU 201 selects a predetermined number of chat messages (three, for example) from the chat message list stored in the ROM 202.

FIG. 29 is a figure showing an example of a chat message list. A four-digit number for identifying a chat message, and a chat message corresponding to the number are stored in the leftmost column. These indicate a first message. The column on the right side thereof has stored therein three first response messages with respect to one first message. Furthermore, the column on the right side thereof has stored therein three second response messages with respect to one first response message. The first message is a message which is displayed on the first display 11 of the terminal device 1 into which the instruction for performing chatting is inputted by touching the chat button 92 using the touch panel 14 (see FIG. 30B). The first response message is a message displayed on the first display 11 of the terminal device 1 which receives the first message (see FIG. 30D). The second response message is, although not shown, a message displayed on the first display 11 of the terminal device 1 which receives the first response message.

After executing the processing of the step S337, the CPU 201 transmits a display command for displaying a chat window having the chat message selected in the step S337 to the terminal device 1 (step S338). This processing corresponds to the step S154 of FIG. 27.

In the step S336, when it is determined that the chat execution command is not received, or when the processing of the step S338 is executed, the CPU 201 determines whether or not the chat message and the destination data are received (step S339). This processing corresponds to the step S162 of FIG. 27. When it is determined in the step S339 that the chat message and the destination data are received, the CPU 201 specifies the terminal device 1, which is the destination of the chat message, on the basis of the destination data (step S340), and transmits the display command for displaying the chat message to the terminal device 1 which is the destination (step S341). This processing corresponds to the step S154 of FIG. 27.

Next, the CPU 201 refers to the player information stored in the RAM 203 (see FIG. 14), and determines whether or not the predetermined condition for mission termination is satisfied (step S342). When it is determined that the predetermined condition for mission termination is not satisfied, the processing is returned to the step S330, and when it is determined that the predetermined condition for mission termination is satisfied, the sub routine ends.

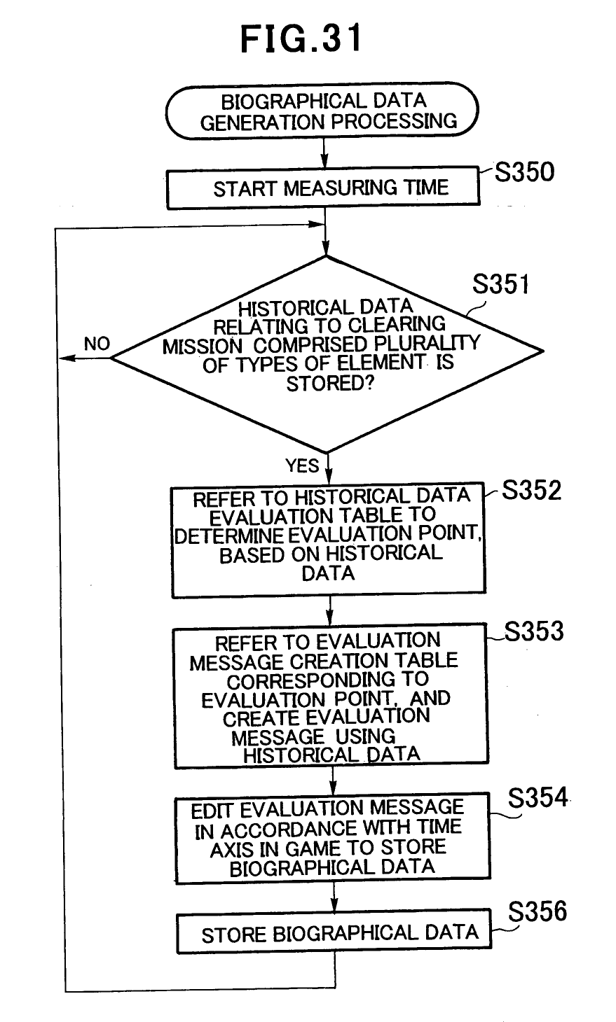

FIG. 31 is a flow chart showing a biographical data generation processing which is executed by the center server 3. This processing is executed when a game related to the present embodiment is started. First of all, the CPU 301 starts a timing processing for measuring a time elapsed since the game related to the present embodiment is started (step S350). This processing may include setting a timer in the RAM 303 to measure an elapsed time by performing an interruption processing or the like at a predetermined cycle to count up the timer value stored in the RAM 303, or providing a timer in the control portion 300. The time axis in the game is configured by the elapsed time measured by the center server 3. It should be noted that the current time may be acquired through the Internet at a predetermined cycle, instead of performing the processing of the step S350.

Next, the CPU 301 determines whether or not the RAM 303 has stored therein the historical data comprising a plurality of types of elements related to clearing a mission (see FIG. 13B) (step S351). It should be noted that when the terminal device 1 executes the processing of the step S123 of the sub routine shown in FIG. 15, the game history related to the player who operates the terminal device 1 is transmitted from the arcade server 2 to the center server 3, and the game history is stored in the RAM 303. The step S351 is performed to determine whether or not game history comprising a plurality of types of elements related to clearing a mission exists in the game history newly stored in the RAM 303.

The CPU 301 then refers to the historical data evaluation table stored in the ROM 302 on the basis of the historical data stored in the RAM 303 (see FIG. 13B), and determines an evaluation point (step S352). FIG. 32 is a figure showing an example of the historical data evaluation table. In the historical data evaluation table, en element of a game history is related to an evaluation point for each mission. For example, in the case of the mission “AA”, the evaluation point is 1 if the level at that time is 3 or lower, and the evaluation point is 0 if the level is above 3. Therefore, the evaluation is high if a mission is cleared on a low level. Further, the evaluation point is 1 if the time required is within an hour, and the evaluation point is 0 if the time required exceeds one hour. Therefore, the evaluation is high if a mission is cleared in a short period of time. Also, the evaluation point is 1 if the number of participants in a mission is 1, and the evaluation point is 0 if the number of participants exceeds 1 (two or more). Therefore, the evaluation is high if selecting a single mission, instead of multi-missions.

It should be noted that when the historical data evaluation table shown in FIG. 32 is referred to on the basis of the game historical data shown in FIG. 13B, the evaluation point for the mission “AA” of the player “d” is 2, the evaluation point for the mission “AB” is 1, and the evaluation point for the mission “AC” is 2.

After the processing of the step S352, the CPU 301 refers to the evaluation message creation table in accordance with the evaluation point, and creates an evaluation message by using the game history stored in the RAM 303 (step S353). FIG. 33 is a figure showing an example of the evaluation message creation table. In the evaluation message creation table, an evaluation message in the case where the evaluation point is 2 or more, and an evaluation message in the case where the evaluation point is less than 2 are stored for each mission. Each evaluation message has columns for entering an element of the game history, and columns for a fixed phrase, and these columns are arranged alternately. By inserting an element of the game history into each column, an evaluation message can be created.

When creating an evaluation message with reference to the evaluation message creation table shown in FIG. 33 by using the game history data shown in FIG. 13B, the following message can be obtained. Specifically, since the evaluation point for the mission “AA” of the player “d” is 2, the evaluation message is “‘d’ has delivered a package excellently to XX ‘by himself in ’ two hours' at the time of ‘level 2’”, which shows a good evaluation. Furthermore, since the evaluation point for the mission “AB” of the player “d” is 1, the evaluation message is “It took ‘two hours’ for ‘d’ at the time of ‘level 11’ to strike down the monster AA to protect the Princess ●●” by ‘three people’, which is a bad evaluation. When executing the processing of the step S353, for every game history stored in the RAM 303 which functions as the game history storing means, the CPU 301 functions as evaluation message generating means which generates an evaluation message for a game result corresponding to the game history, using the plurality of types of elements of the game history.

After the processing of the step S353, the CPU 301 edits the evaluation message created in the step S353, in accordance with the time axis in the game, and generates biographical data (step S354). For example, in a step S353, when creating evaluation messages for the mission “AA” to “AE” shown in FIG. 13B, these evaluation messages are edited in accordance with the time axis in the game in the step S354, thus the evaluation messages are listed in the order of the missions “AA”, “AC”, “AD”, “AE”, and “AB”. When executing the processing of the step S354, the CPU 301 functions as the biographical data generating means which evaluates a plurality of evaluation messages in accordance with the time axis in the game to generate biographical data showing a game process of the player. Next, the CPU 301 stores the biographical data in the RAM 303 (step S356), and returns the processing to the step S351.

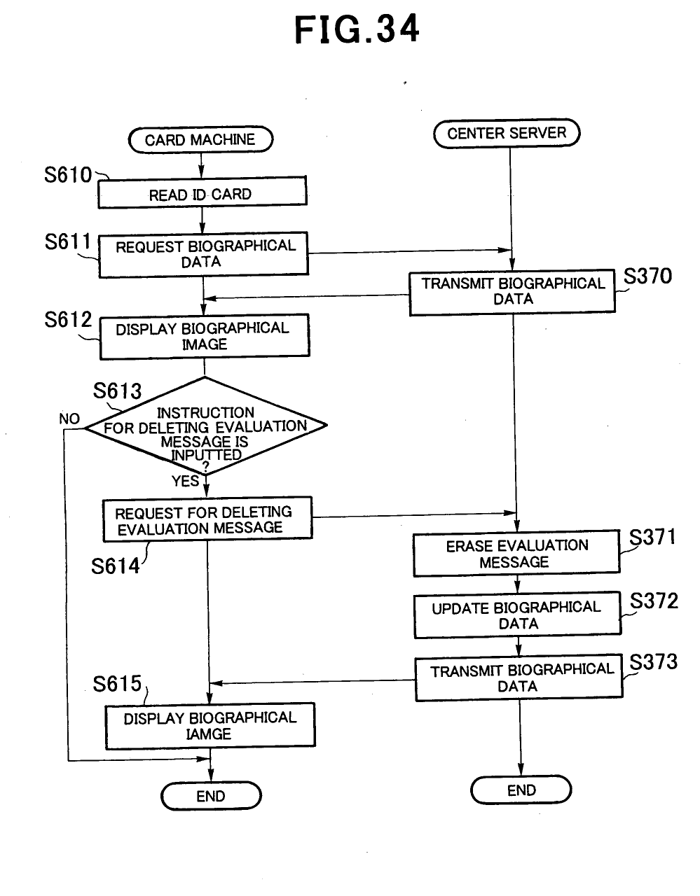

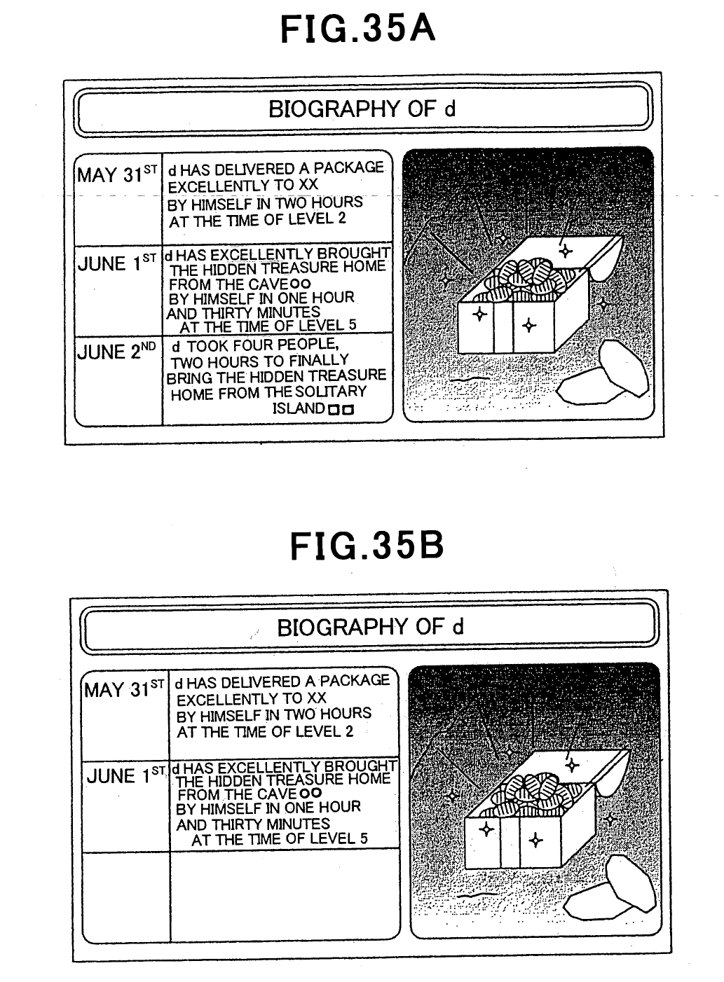

FIG. 34 is a flow chart showing a processing which is executed by the card machine 6 and center server 3 when displaying a biographical image. FIGS. 35A and 35B are figures showing an example of biographical images displayed on a display 61 of the card machine 6 when the processing shown in FIG. 34 is executed. First, the CPU 601 reads out the ID data of the player from the ID card 8 by means of the ID card reader 616 (step S610). The CPU 601 which reads out the ID data from the ID card 8 using the ID card reader 616 transmits a request signal for requesting the biographical data corresponding to the ID data to the center server 3 through the arcade server 2 via the dedicated line 5 by means of the communication interface circuit 604 (step S611). Once receiving the request signal, the CPU 301 of the center server 3 extracts the biographical data corresponding to the ID data from the biographical data stored in the RAM 303 (biographical data which is stored in the RAM 303 in the step S356 of FIG. 31), and transmits this biographical data to the card machine 6 which is the source of the request signal (step S370). Further, the CPU 301 may extract the image data showing the detail of the biographical data from the ROM 302, along with the biographical data, and transmits this image data along with the biographical data.

The CPU 601 of the card machine 6 which receives the abovementioned biographical data from the center server 3 displays a biographical image as shown in FIG. 35A on the display 61 by means of the rendering process portion 611 on the basis of the abovementioned biographical data (step S612). At this time the rendering process portion 611 functions as the biographical image displaying means which generates a biographical image representing the biographical data, and displays the biographical image.

FIG. 35A is a figure showing an example of the biographical image displayed on the display 61 of the card machine 6 when the processing shown in FIG. 34 is executed. An image such as “biography of d” is disposed on the upper side of the screen. A biographical image showing the biographical data in the form of a drawing is disposed on the left side of the screen. Specifically, an evaluation message related to clearing a mission, and the date when the mission is cleared are related to each other and disposed. The two evaluation messages from the top show a good evaluation, and the bottom evaluation message shows a bad evaluation. Also, an image showing the detail of the biographical data is disposed on the right side of the screen.

Next, it is determined whether or not an instruction for deleting an evaluation message is inputted by an operation of the player (step S613). The player can input this instruction by operating the operation button 618 of the card machine 6. When it is determined that the instruction for deleting an evaluation message is not inputted, the sub routine ends.

On the other hand, when it is determined that the instruction for deleting an evaluation message is inputted, the CPU 601 transmits a request signal for requesting deletion of an evaluation message to the center server 3 (step S614). Once receiving the request signal, the CPU 301 of the center server 3 performs a processing for erasing an evaluation message from the RAM 303 on the basis of the request signal (step S371). At this time the CPU 301 functions as the evaluation message erasing means which erases an evaluation message generated by the CPU 301 functioning as the evaluation message generating means. Next, the CPU 301 updates the biographical data stored in the RAM 303 based on a result of the processing of the step S371 (step S372), and transmits the updated biographical data to the card machine 6 (step S373). The CPU 601 of the card machine 6 which receives the updated biographical data from the center server 3 displays the biographical image as shown in FIG. 35B on the display 61 using the rendering process portion 611, on the basis of the abovementioned biographical data (step S615).

FIG. 35B is a biographical image displayed on the display 61 when the instruction for deleting an evaluation message on the bottom (evaluation message showing a bad evaluation) is inputted during the biographical image of FIG. 35A is displayed on the display 61 of the card machine 6, wherein the evaluation message on the bottom is deleted.

As above, according to the game system of the present embodiment, since the biographical image having a plurality of evaluation messages is displayed as shown in FIGS. 35A and 35B, the game process of the player can be understood by means of the biographical image. As a result, a successful player can feel superior and satisfied by repeatedly viewing his own biographical image. Moreover, other player can proceed with the game by referring the game result or having same as an object. Furthermore, since the biographical data is generated for each player, even a beginner can enjoy by viewing the biographical image showing the biographical data for his own game process.

Further, according to the present embodiment, an evaluation message is created for every condition cleared, thus the other player can refer to the evaluation message or have same as an object when challenging the conditions, and a spirit of competition of other player can be encouraged more.

The game system of the present embodiment comprises the evaluation message erasing means which erases an evaluation message in accordance with an operation of a player, thus an evaluation message with which the player cannot satisfied can be erased, as shown in FIG. 35B. Therefore, the evaluation message erasing means can promote to create an evaluation message with which the player can satisfied, whereby the player can be caught up in the game.

The present embodiment explains the case in which the biographical image is displayed on the display 61 of the card machine 6. However, the present invention is not limited to this example, thus the biographical image may be displayed on the first display 11 or second display 12 of the terminal device 1. Moreover, the game system of the present invention may be configured such that the biographical image, biographical data, or the like can be downloaded on a storage medium (for example, ID card 8, etc) possessed by the player. In this case, the players can enjoy the game by showing the biographical images representing their own biographical data to each other.

The present embodiment explains the case in which the RAM 203 of the arcade server 2 and the RAM 303 of the center server 3 functions as the game history storing means, the CPU 201 of the arcade server 2 functions as the game history setting means, the CPU 301 of the center server 3 functions as the evaluation message generating means, biographical data generating means, and evaluation message erasing means, and the rendering process portion 611 of the card machine 6 functions as the biographical image displaying means. However, the present invention is not limited to this example. It is possible to appropriately select any one of the means which configure the present invention for providing with any one of the terminal device 1, arcade server 2, center server 3, or card machine 6.

The present embodiment explains the game system which comprises the plurality of terminal devices 1, the arcade server 2 connected communicably with the plurality of terminal devices 1 via the dedicated lines 5, and the center server 3 connected with the plurality of arcade servers 2 via the communication lines 4. However, the present invention is not limited to this example. For example, the present invention can be applied to a game system composed of a single game device (terminal device), a game system connected with a plurality of game devices (terminal devices) via communication lines, a game system in which a plurality of game devices (terminal devices) are connected to the server via the Internet, and other game system.

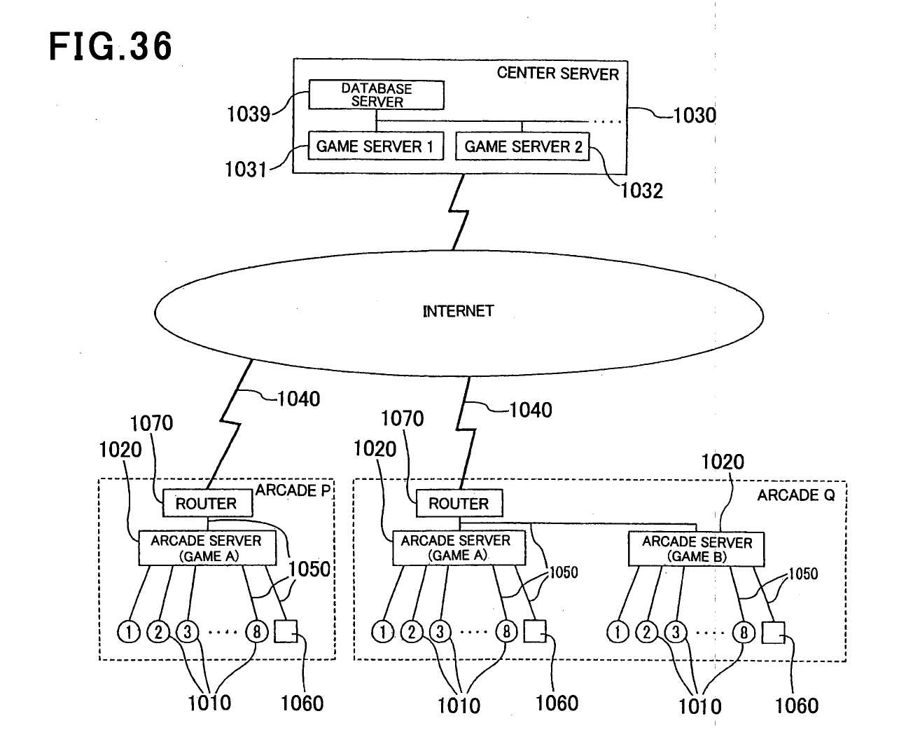

Next, another example of the game system according to the present invention is described. FIG. 36 is a configuration diagram showing another example of the game system according to the present invention. The game system comprises a plurality of terminal devices 1010, a arcade server 1020 connected communicably to the plurality of terminal devices 1010 via dedicated lines 1050, and a center server 1030 connected communicably to the plurality of arcade servers 1020 via communication lines 1040, and also a card machine 1060 for each arcade, which is connected to the arcade server 1020 via the dedicated line 1050. It should be noted that an arcade server 1020 for a game A, and an arcade server 1020 for a game B are installed in an arcade Q.

The center server 1030 comprises a database server 1039, and a plurality of game servers 1031,1032, and the like. The database server 1039 performs (1-1) data management for every ID data granted to each player, (1-2) authentication of a player at the time of a game start, and (1-3) transmission processing of game data.

Specifically, the database server 1039 manages (arcades, sets, updates, and the like) ID data granted to each player, a password used when authenticate the player, the type of a game played by the player, the game data, and the like, regarding the abovementioned (1-1). Moreover, the game data includes, for example, the proceeding state of the game (character specific data, and the like), a character operated by the player, a level value or capability value of the character, an increased or decreased value in the capability value, and the like.

The database server 1039 also uses, for example, the ID data and password to authenticate the player, and permits participation in the game, regarding the abovementioned (1-2). Regarding the abovementioned (1-3), the database server 1039 further transmits the data of the character, from among the abovementioned game data, to the terminal device 1 on the basis of, for example, the ID data of the player.

The game servers 1031, 1032, and the like are installed in accordance with each executable game in the game system according to the present embodiment. It should be noted that one of the plurality of game servers corresponds to the game according to the present embodiment. The game servers 1031, 1032, and the like (also referred to as “game servers 1031 and the like” hereinafter) performs (2-1) a matching processing between the terminal devices 1010 installed in different arcades, and (2-2) traffic control for data transmission after matching.

Specifically, regarding the abovementioned (2-1), the game servers 1031 and the like determine, when a player participates in a game by operating the terminal device 1010, whether or not other player participates in the game. When it is determined that other player participates in the game, the game servers 1031 and the like matches the terminal device 1010 with a terminal device 1010 operated by the abovementioned other player. On the other hand, when it is determined that other player does not participate in the game, a CPU player is set. When setting the CPU player, the arcade server 1020 may be set as the CPU player, or the center server 1030 (or example, the game servers 1031 and the like) may be set as the CPU player.

The game servers 1031 and the like also performs traffic control for data transmission between the terminal devices 1 which are subjected to matching by the matching processing of the (2-1), regarding the abovementioned (2-2). For example, the game servers 1031 and the like transmit the data received from the terminal device 1, which is connected to the arcade server (for the game A) 1020 of an arcade P, to the terminal device 1 which is connected to the arcade server (for game A) 1020 of the arcade Q. In this manner, the arcade server 1020 according to the present embodiment directly receives the data only from the center server 1030, and does not perform data transmission directly between the arcade servers 1020.

The arcade server 1020 is connected to the center server 1030 via a router 1070. The router 1070 has a predetermined routing table. In the case where the plurality of arcade servers 1020 are installed in the same arcade, as with the case of the arcade Q shown in the figure, once receiving game data and the like from the center server 1030, the router 1070 refers to the routing table, and transmits the game data to the arcade server 1020 connected to the terminal device 1010, which is the destination, via the dedicated line 1050. Furthermore, in the case of performing data transmission between the terminal devices 1010 connected to each of the plurality of arcade servers 1020 installed in the same arcade, once receiving game data and the like from the terminal device 1010 via the arcade server 1020, the router 1070 refers to the routing table, and transmits the game data to the arcade server 1020 connected to the terminal device 1010, which is the destination, via the dedicated line 1050.

The arcade server 1020 performs (3-1) traffic control for data transmission between the center server 1030 and the terminal device 1010, or between the terminal devices 1010 connected to each of the plurality of arcade servers 1020 installed in the same arcade, and (3-2) downloading an application to the terminal device 1.

Specifically, regarding the abovementioned (3-1), the arcade server 1020 performs traffic control for transmission of the game data and the like between the center server 1030 and the terminal device 1010. However, when the terminal device 1010 as the destination is connected to the same arcade server 1020 or to a different arcade server 1020 installed in the same arcade, the game data and the like is not transmitted to the center server 1030, but to the terminal device 1010.

Moreover, regarding the abovementioned (3-2), at the time when a request signal for requesting downloading from the center server 1030 is received from the terminal device 1010, the arcade server 1020 downloads an application to this terminal device 1010. The application includes various data for the detail of a game (for example, image data, and the like), and a program, as well as a program for a board for allocating the functions on the game to input means (for example, a plurality of input switches, or the like, which is not shown) that the terminal device 1010 comprises. Further, downloading an application is performed not only by the arcade server 1020, but also by the center server 1030.

The terminal device 1010 is connected to the arcade server 1020 via the dedicated line 1050. The terminal device 1010 (4-1) performs downloading of an application, and (4-2) proceeds with a game. Specifically, regarding the abovementioned (4-1), once the power is turned on, the terminal device 1010 transmits a request signal for requesting downloading of an application to the arcade server 1020 and downloads an application. The downloaded application is stored in a region in a RAM or the like of the terminal device 1010 where the application can be stored temporarily. Moreover, regarding the abovementioned (4-2), the terminal device 1010 uses the downloaded application to proceed with a game. The game is proceeded as follows. The terminal device 1010 receives data for every ID data granted to each player by the database server 1039 at the time of a game start. During the game, the data of the terminal device 1010 in the same game and of other terminal device 1010 is transmitted/received through the center server 1030 via the arcade server 1020. However, when the abovementioned other terminal device 1010 is connected to the same arcade server 1020, or is connected to a different arcade server 1020 installed in the same arcade, the game data and the like are not transmitted to the center server 1030 but to the terminal device 1010. When the game ends, the game data which is updated during the game, or a game result itself is transmitted to the database server 1039. It should be noted that not only the terminal device 1010, but also the arcade server 1020 may perform proceeding of the game.

The card machine 1060 can communicate with the center server 1030 via the arcade server 1020. The card machine 1060 accepts an input operation of the personal information, which is performed by a player, and sells an ID card in which the ID data is stored. The ID card is used when a game is started, and the ID data is read by the ID card reader which the terminal device 1010 comprises.

In the present embodiment, the RAM which the database server 1039 of the center server 1030 comprises functions as the game history storing means which can store a plurality of game histories of players, which comprise a plurality of types of elements. The CPU which the game servers 1031 and the like of the center server 1030 comprise functions as the game history setting means which sets the game histories comprising the plurality of types of elements based on a game result of a player, relates the game histories to the time on the game, and store the game histories in the RAM (game history storing means) of the database server 1039. The CPU which the game servers 1031 and the like of the center server 1030 comprise functions as the evaluation message generating means which uses the plurality of types of elements of the game histories to generate an evaluation message for the game result corresponding to the game history, for each game history stored in the RAM (game history storing means) of the database server 1039. The CPU which the game servers 1031 and the like of the center server 1030 comprise functions as the biographical data generating means which edits a plurality of evaluation message generated by the abovementioned evaluation message generating means in accordance with the time axis in the game, and generates biographical data representing a game process of a player. A first rendering process portion which the terminal device 1010 comprises functions as the biographical image displaying means which generates a biographical image representing the biographical data generated by the abovementioned biographical data generating means, and display the biographical image on a first display.

Embodiments of the present invention is explained above. However, the embodiments merely illustrate concrete examples, and do not particularly limit the present invention, thus specific configurations for the means and the like can be changed accordingly in terms of the design. Further, the effects described in the embodiments of the present invention merely mention the most suitable effects generated by the present invention, thus the effects of the present invention are not limited to those described in the embodiments of the present invention.

What is claimed is:

1. A game system in which at least a plurality of terminal devices are connected to servers via a communication line, and which can execute a game which a plurality of players play by operating each of the terminal devices, the game system comprising:
a game history storing unit which can store a plurality of game histories of a player, which comprise a plurality of types of elements;
a game history setting unit which sets the game histories comprising the plurality of types of elements on the basis of a game result of the player, and stores the game histories in the game history storing unit after relating the game histories to the time in the game;
an evaluation message generating unit which generates an evaluation message for the game result corresponding to the game histories by means of the plurality of types of elements of the game histories for each game history stored in the game history storing unit;
an evaluation message group generating unit which edits the plurality of evaluation messages generated in the evaluation message generating unit in accordance with the time axis in the game, and generates an evaluation message group which represents a game process of the player; and
a displaying unit which generates an image constituted by the evaluation message group representing the evaluation message group generated by the evaluation message group generating unit, and displays the image constituted by the evaluation message group.

2. The game system according to claim 1, comprising an evaluation message erasing unit for erasing the evaluation message which is generated by the evaluation message generating unit, in accordance with an operation of the player.

3. The game system according to claim 1, comprising:
a condition setting unit which sets a condition to be cleared for a player; and
a condition achievement determination unit which determines whether or not the player clears the condition,
wherein, when the condition achievement determination unit determines that the player clears the condition, the game history setting unit sets a game history comprising a plurality of types of elements on the basis of a result of clearing the condition, and stores the game history in the game history storing unit after relating same to the time in the game.

4. The game system according to claim 1, wherein the server comprises an arcade server connected communicably to the plurality of terminal devices via dedicated lines, and a center server connected communicably to the plurality of arcade servers via communication lines.

5. The game system according to claim 1, wherein the game history comprises at least two elements of the elements of a date and hour of participation, a participating player, the level of the participating player at the time of participation, a clearing time, and a reward acquired.

6. The game system according to claim 1, wherein the displaying unit is provided in the terminal device or a card machine.

7. The game system according to claim 4, configured such that the game history is once stored in the memory of the arcade server, and the game history stored in the memory of the arcade server is transmitted to the center server when the game ends.

8. The game system according to claim 4, wherein the evaluation message generating unit is provided inside the center server.

9. The game system according to claim 4, wherein calculation of a time of the time axis in the game is performed based on a timer value provided in the center server.

10. The game system according to claim 4, wherein the game history setting unit is provided in the arcade server, the game history storing unit is provided in the arcade server or the center server, and the evaluation message generating unit and the evaluation message group generating unit are provided in the center server.

11. The game system according to claim 2, wherein the server comprises the arcade server connected communicably to the plurality of terminal devices via dedicated lines, and the center server connected communicably to the plurality of arcade servers via communication lines, and the evaluation message erasing unit is provided in the center server, in which, on the basis of a request signal for erasing an evaluation message transmitted to the center server, erasing processing is performed on the evaluation message.

12. A server, which is connected to at least a plurality of terminal devices via communication lines, and configures a game system in which a plurality of players can execute a game by operating the terminal devices respectively, the server comprising:
a game history storing unit in which a plurality of game histories of the players, which comprise a plurality of types of elements, are stored;
a game history setting unit which sets the game histories comprising the plurality of types of elements on the basis of a game result of the player, and stores the game histories in the game history storing unit after relating the game histories to the time in the game;
an evaluation message generating unit which employs the plurality of types of elements of the game histories to generate evaluation messages for game results corresponding to the game histories, for each game history stored in the game history storing unit; and
an evaluation message group generating unit which edits the plurality of evaluation messages generated by the evaluation message generating unit in accordance with a time axis in the game, and generates an evaluation message group representing the game processes of the players.

13. A game control method, which causes a server to function as:
a game history storing unit in which a plurality of game histories of the players, which comprise a plurality of types of elements, are stored;
a game history setting unit which sets the game histories comprising a plurality of types of elements on the basis of a game result of the player, and stores the game histories in the game history storing unit after relating the game histories to the time in the game;
an evaluation message generating unit which employs the plurality of types of elements of the game histories to generate evaluation messages for game results corresponding to the game histories, for each game history stored in the game history storing unit;
an evaluation message group generating unit which edits the plurality of evaluation messages generated by the evaluation message generating unit in accordance with a time axis in the game, and generates an evaluation message group representing the game processes of the players; and
a displaying unit which generates an image configured by the evaluation message group representing the evaluation message group which is generated by the evaluation message group generating unit, and displays the image configured by the evaluation message group,
wherein the server is connected to at least a plurality of terminal devices via communication lines, and configures game system in which a plurality of players can execute a game by operating the terminal devices.
